(19) United States
(12) Patent Application Publication
(10) Pub. No.: US 2026/0118809 A1
(43) Pub. Date: Apr. 30, 2026

(54) CONVEYING DEVICE, IMAGE READING DEVICE, IMAGE FORMING APPARATUS, ANOMALY DETECTING APPARATUS, AND ANOMALY DETECTING SYSTEM

(71) Applicant: Yusuke NAKAI, Kanagawa (JP)

(72) Inventor: Yusuke NAKAI, Kanagawa (JP)

(73) Assignee: Ricoh Company, Ltd., Tokyo (JP)

(21) Appl. No.: 19/324,742

(22) Filed: Sep. 10, 2025

(30) Foreign Application Priority Data
Oct. 25, 2024 (JP) 2024-188074
Jun. 17, 2025 (JP) 2025-101224

(51) Int. Cl. G03G 15/00

(52) U.S. Cl. CPC G03G 15/602; G03G 15/5012; G03G 15/605; G03G 15/607; G03G 2215/00194; G03G 2215/00329; G03G 2215/00548

(57) ABSTRACT

A conveying device includes a receptacle, an imager, and circuitry. The receptacle receives a medium. The imager captures an image of the medium. The circuitry acquires image information of the medium captured by the imager, and performs control based on at least one of a condition or a type of the medium. The at least one of the condition or the type is recognized based on the acquired image information.

### CROSS-REFERENCE TO RELATED APPLICATIONS

This patent application is based on and claims priority pursuant to 35 U.S.C. § 119(a) to Japanese Patent Application Nos. 2024-188074, filed on Oct. 25, 2024, and 2025-101224, filed on Jun. 17, 2025, in the Japan Patent Office, the entire disclosure of each of which is hereby incorporated by reference herein.

### BACKGROUND

### Technical Field

The present disclosure relates to a conveying device, an image reading device, an image forming apparatus, an anomaly detecting apparatus, and an anomaly detecting system.

### Related Art

Image forming apparatuses often include an automatic document reader. When the automatic document reader attempts to read a document that is not recommended for reading by the automatic document reader, anomalies may be detected after the conveyance of the document is started. In this case, the document may be damaged due to, for example, a paper jam occurring during the conveyance.

### SUMMARY

The present disclosure described herein provides a conveying device including a receptacle, an imager, and circuitry. The receptacle receives a medium. The imager captures an image of the medium. The circuitry acquires image information of the medium captured by the imager, and perform control based on at least one of a condition or a type of the medium. The at least one of the condition or the type is recognized based on the acquired image information.

The present disclosure described herein provides an image reading device including the conveying device and a reader to read information represented on the medium conveyed by the conveying device.

The present disclosure described herein provides an image forming apparatus including the image reading device and an image forming device to form an image on another medium based on the information read by the image reading device.

The present disclosure described herein provides an anomaly detecting apparatus including a communication device and circuitry. The communication device receives information indicating that a medium is placed on a receptacle of an image reading device, from the image reading device that reads information represented on the medium while conveying the medium. The circuitry generates, in response to the information received by the communication device, information indicating whether to read the medium based on at least one of a condition or a type of the medium. The at least one of the condition or the type is recognized based on image information of the medium captured by an imager. The communication device transmits the generated information to an image forming apparatus.

The present disclosure described herein provides an anomaly detecting system including an image forming apparatus and an information processing apparatus. The image forming apparatus includes a reading device, an imager, first circuitry, a first communication device, and an image forming device. The reading device conveys a medium from a receptacle to read information represented on the medium. The imager captures an image of the medium. The first circuitry acquires image information of the medium captured by the imager. The first communication device transmits the acquired image information to the information processing apparatus and receives information indicating whether to read the medium based on the image information from the information processing apparatus. The first circuitry performs control based on the received information. The image forming device forms an image on another medium based on the information read by the reading device. The information processing apparatus includes a second communication device and second circuitry. The second communication device receives the image information. The second circuitry generates information indicating whether to cause the reading device to read the medium based on at least one of a condition or a type of the medium. The at least one of the condition or the type is recognized based on the received image information. The second communication device transmits the generated information to the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a copier according to a first embodiment;

FIG. 2 is a perspective view of a scanner and an automatic document feeder (ADF) of the copier according to the first embodiment;

FIG. 3 is an enlarged view of the ADF with an upper portion of the scanner according to the first embodiment;

FIG. 4 is a block diagram illustrating a part of an electric circuit of the copier according to the first embodiment;

FIG. 5 is a block diagram illustrating a configuration of a main control unit and an artificial intelligence (AI) accelerator according to the first embodiment;

FIG. 6 is a perspective view of the ADF according to the first embodiment;

FIG. 7 is a flowchart of a process performed by the main control unit to start reading a document according to the first embodiment;

FIG. 8 is a diagram illustrating a change in image data acquired from a camera by an acquisition unit according to the first embodiment;

FIG. 9 is a diagram illustrating a first example of a screen displayed by a display control unit according to the first embodiment;

FIG. 10 is a diagram illustrating a second example of the screen displayed by the display control unit according to the first embodiment;

FIG. 11 is a diagram illustrating a third example of the screen displayed by the display control unit according to the first embodiment;

FIG. 12 is a diagram illustrating a fourth example of the screen displayed by the display control unit according to the first embodiment;

FIG. 13 is a diagram illustrating a fifth example of the screen displayed by the display control unit according to the first embodiment;

FIG. 14 is a diagram illustrating a configuration of a main control unit according to a modified first embodiment;

FIG. 15 is a flowchart of a process performed by the main control unit to update a trained model according to the modified first embodiment;

FIG. 16 is a perspective view of an ADF and a camera according to a second embodiment;

FIG. 17 is a block diagram illustrating a part of an electric circuit of the copier according to the second embodiment;

FIG. 18 is a perspective view of an ADF and a camera according to a modified second embodiment;

FIG. 19 is a block diagram illustrating a part of electric circuits of a copier and an anomaly detector according to a third embodiment;

FIG. 20 is a block diagram illustrating a part of electric circuits of a copier and a server according to a fourth embodiment;

FIG. 21 is a block diagram illustrating a part of electric circuits of a copier and a communication terminal according to a fifth embodiment;

FIG. 22 is a diagram illustrating a configuration of a main control unit according to a fifth embodiment;

FIG. 23 is a flowchart of a process performed by the main control unit to start reading a document according to the fifth embodiment; and

FIG. 24 is a diagram illustrating an example of capturing, with a camera, an image of a transfer sheet set in a manual sheet feeder of a copier according to a sixth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

Embodiments of a conveying device, an image reading device, an image forming apparatus, an anomaly detecting apparatus, and an anomaly detecting system are described below in detail with reference to the accompanying drawings.

### First Embodiment

An image forming apparatus may be, for example, a full-color multifunction peripheral, product, or printer (MFP) that forms color images by electrophotography.

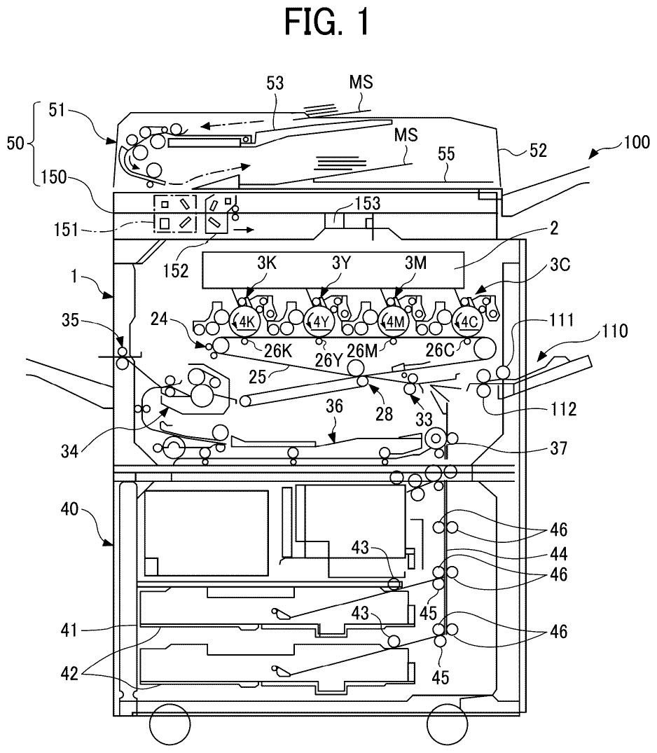

Initially, a basic configuration of a copier is described below. FIG. 1 is a schematic diagram illustrating a configuration of a copier 100, which is an example of a conveying device that conveys a medium, or an example of an image forming apparatus that forms an image on a medium. The copier 100 includes an image forming device 1, a blank sheet feeding device 40, and a document reading device 50. The document reading device 50 includes a scanner 150 fixed on the image forming device 1, and an automatic document feeder (ADF) 51 supported by the scanner 150. The ADF 51 is an example of a document conveying device.

The blank sheet feeding device 40 includes two sheet trays 42 serving as sheet placement sections vertically disposed in a paper bank 41. The blank sheet feeding device 40 further includes feed rollers 43 serving as feeding members that feed transfer sheets from the sheet trays 42, and separation rollers 45 serving as separation members that separate the fed transfer sheets one by one and feed the separated transfer sheet to a sheet feeding passage 44. The blank sheet feeding device 40 further includes multiple conveyance rollers 46 that convey transfer sheets to a sheet feeding passage 37 in the image forming device 1. The blank sheet feeding device 40 feeds transfer sheets from the sheet trays 42 into the sheet feeding passage 37 in the image forming device 1.

The copier 100 includes a manual sheet feeder 110 in addition to the blank sheet feeding device 40. The manual sheet feeder 110 includes a feed roller 111 serving as a feeding member that feeds transfer sheets set in the manual sheet feeder 110, a separation roller 112 serving as a separation member that separates the fed transfer sheets one by one and supplies the separated transfer sheet to a registration roller pair 33.

The image forming device 1, serving as an image forming unit, forms an image on a transfer sheet, which is an example of another medium, based on information read by the document reading device 50. The image forming device 1 includes an optical writing device 2, four process units 3K, 3Y, 3M, and 3C that form toner images of black (K), yellow (Y), magenta (M), and cyan (C) colors, respectively, and a transfer unit 24. The image forming device 1 further includes a sheet conveying unit 28, the registration roller pair 33, a fixing device 34, a switchback device 36, and the sheet feeding passage 37. The optical writing device 2 drives light sources such as laser diodes or light-emitting diodes (LEDs) disposed in the optical writing device 2 to irradiate four drum-shaped photoconductors 4K, 4Y, 4M, and 4C with laser light. This irradiation forms electrostatic latent images on the surfaces of the photoconductors 4K, 4Y, 4M, and 4C. The latent images for each KYMC color are then developed into toner images through a predetermined developing process. The suffixes K, Y, M, and C appended to the reference numerals indicate specifications for black, yellow, magenta, and cyan, respectively. To simplify the description, these suffixes may be omitted unless necessary in the following description.

The copier 100 has a so-called tandem configuration in which the four process units 3K, 3Y, 3M, and 3C are aligned opposite to an intermediate transfer belt 25 in the direction of the looped movement of the intermediate transfer belt 25.

K, Y, M, and C toner images are formed on the photoconductors 4K, 4Y, 4M, and 4C of the respective four process units 3K, 3Y, 3M, and 3C through a predetermined process.

The transfer unit 24 is disposed below the four process units 3K, 3Y, 3M, and 3C. The transfer unit 24 moves the intermediate transfer belt 25, which is stretched around multiple rollers, along a continuous loop in a clockwise direction in FIG. 1 while the intermediate transfer belt 25 is in contact with the photoconductors 4K, 4Y, 4M, and 4C. Thus, primary transfer nips for K, Y, M, and C are formed where the photoconductors 4K, 4Y, 4M, and 4C and the intermediate transfer belt 25 are in contact with each other. Near the primary transfer nips for K, Y, M, and C, primary transfer rollers 26K, 26Y, 26M, and 26C, which are disposed inside a loop formed by the intermediate transfer belt 25, press the intermediate transfer belt 25 toward the photoconductors 4K, 4Y, 4M, and 4C. A primary transfer bias is applied to each of the primary transfer rollers 26K, 26Y, 26M, and 26C by a power source. This application of the primary transfer bias generates a primary transfer electric field at each of the primary transfer nips for K, Y, M, and C. This field electrostatically moves the toner images from the photoconductors 4K, 4Y, 4M, and 4C toward the intermediate transfer belt 25. The toner images are superimposed one atop another, and thus, sequentially transferred at the primary transfer nips onto the outer surface of the intermediate transfer belt 25, which sequentially passes through the primary transfer nips for K, Y, M, and C in accordance with the looped movement in the clockwise direction in FIG. 1. The primary transfer of the superimposed toner images forms a four-color superimposed toner image on the outer surface of the intermediate transfer belt 25. The four-color superimposed toner image may be referred to simply as “four-color toner image” in the following description.

The four-color toner image on the intermediate transfer belt 25 is secondarily transferred onto the transfer sheet at once. As a result, a full-color image is formed together with the white color of the transfer sheet. The transfer sheet is separated from the intermediate transfer belt 25 and conveyed to the fixing device 34 along with the looped movement of the intermediate transfer belt 25.

The fixing device 34 fixes the full-color image under heat and pressure onto the transfer sheet conveyed to the fixing device 34. The transfer sheet bearing the fixed full-color image is conveyed from the fixing device 34 to an output roller pair 35, which ejects the transfer sheet to the outside of the housing of the image forming device 1.

The switchback device 36 is disposed below the sheet conveying unit 28 and the fixing device 34. The switchback device 36 includes a switching claw, which redirects the transfer sheet—after image fixing on one side—toward the sheet reversing mechanism of the switchback device 36. Once reversed, the transfer sheet undergoes secondary image transfer and fixing on the opposite side. Finally, the transfer sheet is ejected onto an output tray.

The scanner 150, fixed on the image forming device 1, includes a first fixed reader 151 and a movable reader 152. The first fixed reader 151 is an example of a reader or a first reader, whereas the movable reader 152 is an example of another reader or a second reader.

The movable reader 152 serving as the second reader is disposed immediately below a second platen, which is an example of a readable area, fixed to an upper wall of a casing of the scanner 150 so as to contact a document MS. The movable reader 152 is capable of moving an optical system including a light source and reflection mirrors in a lateral direction in FIG. 1. In other words, the movable reader 152 serving as the second reader includes the optical system and is movable in the lateral direction in FIG. 1. In the process of moving the optical system from left to right in FIG. 1, the movable reader 152 reflects light emitted from the light source off the document placed on the second platen, guides the reflected light through multiple reflection mirrors, and receives the light with an image reading sensor 153 fixed to the main body of the scanner 150.

The first fixed reader 151 serving as the first reader is disposed immediately below a first platen fixed to the upper wall of the casing of the scanner 150 so as to contact the document MS. As the document MS conveyed by the ADF 51 described later passes over the first platen, the first fixed reader 151 sequentially reflects light emitted from the light source off the surface of the document MS, guides the reflected light through multiple reflection mirrors, and receives the light with the image reading sensor 153. Accordingly, the first fixed reader 151 scans a first side of the document MS without moving the optical system, which includes the light source and the reflection mirrors.

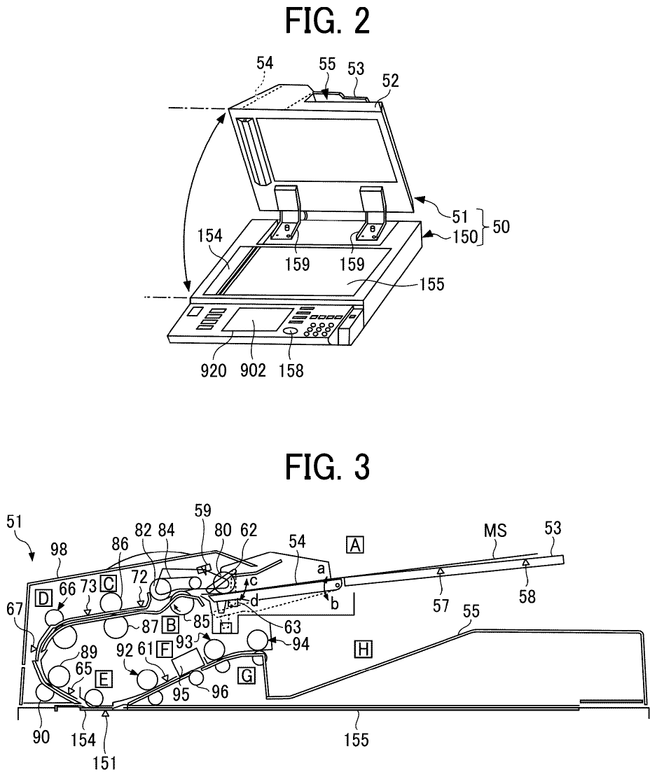

The ADF 51 disposed above the scanner 150 holds, inside a main body cover 52, an ADF input tray 53, which is a document placement tray or table on which documents MS are placed, a conveying unit to convey the documents MS, and an ADF output tray 55, which is a document stacking tray or table where the documents MS are ejected after reading and stacked. The ADF input tray 53 is an example of a receptacle that receives a medium. As illustrated in FIG. 2, the ADF 51 is supported by hinges 159 fixed to the scanner 150 such that the ADF 51 can swing vertically. The ADF 51 moves like a door that opens and closes by swinging. The ADF 51 exposes a first platen 154 and a second platen 155 on the upper surface of the scanner 150 in an open state. In the case of a side-stitched document bundle, such as a book, in which one corner of the bundle is bound together, the individual pages cannot be separated. For this reason, the document bundle cannot be fed through the ADF 51. To scan the side-stitched document bundle, the ADF 51 is first opened as illustrated in FIG. 2. The side-stitched document bundle, with a desired page spread open and facing downward, is placed on the second platen 155, which is an area where documents can be read. Thereafter, the ADF 51 is closed. Then, the image of the page is read by the movable reader 152 of the scanner 150 illustrated in FIG. 1.

In the case of a document bundle formed by simply stacking mutually independent documents MS, the documents MS can be sequentially read by the first fixed reader 151 in the scanner 150 and a contact image sensor in the ADF 51 while being automatically conveyed one by one by the ADF 51.

In this case, after setting the document bundle on the ADF input tray 53, the user presses a copy start button 158. Then, the ADF 51 sequentially feeds the documents MS of the document bundle from the ADF input tray 53, starting from the uppermost document MS, and conveys the documents MS toward the ADF output tray 55 while reversing each document MS. During this conveyance, each document MS is reversed and immediately passes directly above the first fixed reader 151 of the scanner 150. At this time, an image on the first side of the document MS is read by the first fixed reader 151 of the scanner 150. The first side is a surface corresponding to the upper side of the document MS when the document MS is set on the ADF input tray 53.

The copy start button 158 is disposed on an operation panel 902. The operation panel 902 includes a display device 920 in addition to the copy start button 158.

FIG. 3 is an enlarged view of the ADF 51 with an upper portion of the scanner 150. The ADF 51 includes a document setting section A, a separation feeding section B, a registration section C, a turning section D, a first reading and conveying section E, a second reading and conveying section F, an output section G, and a stacking section H. The ADF 51 further includes a document conveyance passage to convey the document MS from the ADF input tray 53 toward the first fixed reader 151 at which images are read.

The document setting section A includes the ADF input tray 53 on which a bundle of documents MS is set. The separation feeding section B separates and feeds the documents MS one by one from the bundle of documents MS set on the ADF input tray 53. The registration section C temporarily abuts against the fed document MS to align the document MS and then feeds the document MS. The turning section D includes a curved conveying section that is curved in a C-shape. The turning section D turns the document MS upside down while turning the document MS back in the curved conveying section. The first reading and conveying section E causes the first fixed reader 151, which is disposed below the first platen 154 inside the scanner 150, to read the first side of the document MS while conveying the document MS over the first platen 154. The second reading and conveying section F causes a second fixed reader 95 to read a second side of the document MS while conveying the document MS under the second fixed reader 95. The output section G ejects the document MS, from which the images on both sides have been read, toward the stacking section H. The stacking section H stacks the documents MS on the ADF output tray 55.

The document MS is set with the leading end on a movable document table 54 and the trailing end on the ADF input tray 53. The movable document table 54 is swingable in directions indicated by arrows “a” and “b” in FIG. 3 according to the thickness of the bundle of documents MS. When the document MS is thus set, side guides are brought into contact with both ends of the document MS on the ADF input tray 53 in a width direction of the ADF input tray 53, which is a direction perpendicular to the surface of the paper on which FIG. 3 is drawn. Thus, the position of the document MS is adjusted in the width direction. The document MS thus set pushes up a lever 62 swingably disposed above the movable document table 54. Then, a document setting sensor 63 detects the setting of the document MS and transmits a detection signal to a controller. The detection signal is transmitted from the controller to a reading control unit of the scanner 150 via an interface (I/F).

The ADF input tray 53 is provided with a first length sensor 57 and a second length sensor 58, which are reflective photosensors or actuator sensors that detect the length of the document MS in a conveyance direction in which the document MS is conveyed. The length of the document MS in the conveyance direction is detected by these length sensors.

A pickup roller 80 is disposed above the bundle of documents MS on the movable document table 54. The pickup roller 80 is supported by a cam mechanism to be movable vertically, in the directions indicated by arrows “c” and “d” in FIG. 3. The cam mechanism is driven by a pickup motor to move the pickup roller 80 up and down. When the pickup roller 80 is moved upward, the movable document table 54 is swung in the direction indicated by arrow “a” in FIG. 3, and the pickup roller 80 contacts the uppermost document MS in the bundle of documents MS. When the movable document table 54 is further raised, a table raising sensor 59 eventually detects the raising of the movable document table 54 to the upper limit. As a result, the pickup motor 56 is stopped, and the raising of the movable document table 54 is stopped.

Operators operate keys, such as a key for selecting a reading mode from a double-sided reading mode or a single-sided reading mode, or press the copy start button 158 on the operation panel 902, including a numeric keypad and a display, on the main body of the copier 100.

When the copy start button 158 is pressed, a document feed signal is transmitted from a main control unit to a controller 904 of the ADF 51. The pickup roller 80 is then driven to rotate by the forward rotation of a sheet feeding motor and feeds the document MS on the movable document table 54 from the movable document table 54.

In setting the reading mode, the double-sided reading mode or the single-sided reading mode can be set collectively for all the documents MS on the movable document table 54. Further, the reading mode may be set individually for each document MS, such as setting the double-sided reading mode for the first and tenth documents MS and setting the single-sided reading mode for the other documents MS.

The document MS fed by the pickup roller 80 enters the separation feeding section B and is fed to a position of contact where the document MS contacts a sheet feeding belt 84. The sheet feeding belt 84, which is stretched by, for example, a driving roller 82, is moved along a continuous loop in the clockwise direction in FIG. 3 by the rotation of the driving roller 82 in accordance with the forward rotation of the sheet feeding motor. A separation roller 85 that is driven to rotate clockwise in FIG. 3 by the forward rotation of the sheet feeding motor contacts a lower stretched face of the sheet feeding belt 84. In an area of contact between the sheet feeding belt 84 and the separation roller 85, the surface of the sheet feeding belt 84 moves in a sheet feeding direction in which the documents MS are fed. When the separation roller 85 is in pressure contact with the sheet feeding belt 84 directly or indirectly with a single document MS sandwiched in the area of contact between the sheet feeding belt 84 and the separation roller 85, the separation roller 85 is rotated together with the sheet feeding belt 84 or the document MS. However, when multiple documents MS are sandwiched in the area of contact, the force exerted by the sheet feeding belt 84 or the document MS to rotate the separation roller 85 together is lower than the torque of a torque limiter. For this reason, the separation roller 85 is driven to rotate clockwise in FIG. 3 opposite to the direction in which the separation roller 85 is rotated together with the sheet feeding belt 84 or the document MS. Accordingly, a moving force in a direction opposite to the sheet feeding direction is applied to the documents MS below the uppermost document MS by the separation roller 85, and only the uppermost document MS is separated from the several documents MS. The operation up to this point may be referred to as “sheet feeding and separating operation” in the following description.

The single document MS, which is separated from the other documents MS by the operations of the sheet feeding belt 84 and the separation roller 85, enters the registration section C. When the document MS passes immediately below an abutment sensor 72, the leading end of the document MS is detected. At this time, the pickup roller 80 receiving the driving force of the pickup motor is still driven to rotate. However, since the pickup roller 80 is separated from the document MS as the movable document table 54 is lowered, the document MS is conveyed simply by the force of the looped movement of the sheet feeding belt 84. The looped movement of the sheet feeding belt 84 continues for a predetermined time from the time when the leading end of the document MS is detected by the abutment sensor 72. As a result, the leading end of the document MS abuts against an area of contact between a pull-out driving roller 86 and a pull-out driven roller 87 that is driven to rotate in contact with the pull-out driving roller 86.

The pull-out driven roller 87 is driven to rotate by the reverse rotation of the sheet feeding motor to convey the document MS to an intermediate roller pair 66, which is disposed downstream from the pull-out driven roller 87 in the conveyance direction. When the sheet feeding motor rotates in reverse, the pull-out driven roller 87 and one of the rollers of the intermediate roller pair 66, the rollers being in contact with each other, start rotating, whereas the looped movement of the sheet feeding belt 84 stops.

At this time, the rotation of the pickup roller 80 is also stopped.

The document MS fed from the pull-out driven roller 87 passes immediately below a document-width sensor 73. The document-width sensor 73 includes multiple sheet detectors, such as reflective photosensors. The sheet detectors are aligned in the width direction of the document MS, which is a direction perpendicular to the surface of the paper on which FIG. 3 is drawn. The size of the document MS in the width direction is detected based on which sheet detector detects the document MS. The length of the document MS in the conveyance direction is detected based on the time from when the leading end of the document MS is detected by the abutment sensor 72 to when the trailing end of the document MS is no longer detected by the abutment sensor 72.

The leading end of the document MS whose size in the width direction is detected by the document-width sensor 73 enters the turning section D and is sandwiched in an area of contact between the rollers of the intermediate roller pair 66. The speed of the document MS conveyed by the intermediate roller pair 66 is set to be higher than the conveyance speed of the document MS in the first reading and conveying section E described later. Accordingly, the time until the document MS is fed to the first reading and conveying section E is shortened.

The leading end of the document MS conveyed in the turning section D passes through a position where the leading end of the document MS faces a reading entrance sensor 67. When the leading end of the document MS is detected by the reading entrance sensor 67, the speed of the document MS conveyed by the intermediate roller pair 66 is reduced by the time when the leading end of the document MS reaches the position of a reading entrance roller pair, which is a pair of rollers 89 and 90, downstream from the reading entrance sensor 67 in the conveyance direction. Meanwhile, in accordance with the initiation of rotation of a reading motor, either the roller 89 or the roller 90 of the reading entrance roller pair, one roller of a first reading exit roller pair 92, and one roller of a second reading exit roller pair 93 start rotating.

In the turning section D, the document MS is turned upside down and the conveyance direction is turned back while the document MS is conveyed in the curved conveyance passage between the intermediate roller pair 66 and the reading entrance roller pair (the pair of rollers 89 and 90). After passing through the nip formed between the rollers 89 and 90 of the reading entrance roller pair, the leading end of the document MS passes immediately below a registration sensor 65. The operation up to this point after the sheet feeding and separating operation may be referred to as “pull-out operation” in the following description.

When the leading end of the document MS is detected by the registration sensor 65, the conveyance speed of the document MS is gradually reduced while the document MS is conveyed over a predetermined distance. When a conveyance motor is stopped, the rotation of the pull-out driving roller 86 and the rotation of the intermediate roller pair 66 are also stopped. When the reading motor is stopped, the rotation of the reading entrance roller pair is also stopped. As a result, the conveyance of the document MS is temporarily stopped at a registration position before the first reading and conveying section E. Further, a registration stop signal is transmitted to a reading control unit.

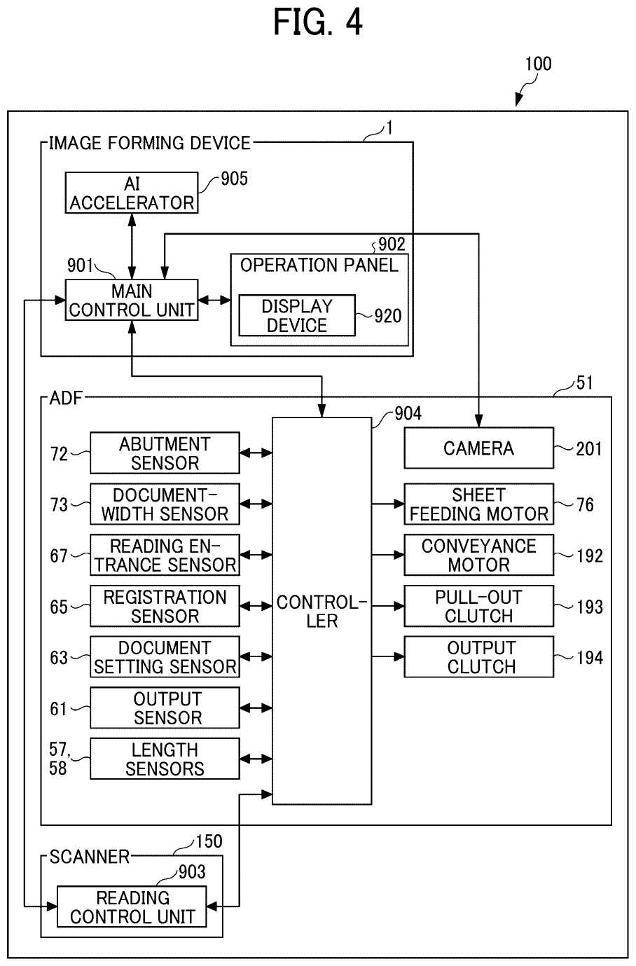

FIG. 4 is a block diagram illustrating a part of an electric circuit of the copier 100. The copier 100 includes the image forming device 1, the ADF 51, and the scanner 150. The scanner 150 includes a reading control unit 903.

The ADF 51 includes the controller 904, which controls various devices and sensors. The controller 904 is connected to, for example, the registration sensor 65, the document setting sensor 63, an output sensor 61, the abutment sensor 72, the document-width sensor 73, the reading entrance sensor 67, and the length sensors 57 and 58 (specifically, the first length sensor 57 and the second length sensor 58). The controller 904 is further connected to, for example, a sheet feeding motor 76, a conveyance motor 192, a pull-out clutch 193, and an output clutch 194. The abutment sensor 72, the document-width sensor 73, and the reading entrance sensor 67 connected to the controller 904 are sensors to detect the documents MS.

The image forming device 1 includes a main control unit 901, the operation panel 902, and an artificial intelligence (AI) accelerator 905.

Each of the main control unit 901 of the image forming device 1, the reading control unit 903 of the scanner 150, and the controller 904 of the ADF 51 includes a central processing unit (CPU), a random-access memory (RAM), a read-only memory (ROM), and an application-specific integrated circuit (ASIC).

The main control unit 901 and the reading control unit 903, the reading control unit 903 and the controller 904, and the controller 904 and the main control unit 901 are each connected to one another and can communicate with their respective pairs.

The conveyance motor 192 connected to the controller 904 is a rotational driving source for the pull-out driving roller 86 and an output roller pair 94 in the ADF 51. The pull-out clutch 193 connected to the controller 904 connects or disconnects the rotational driving force of the conveyance motor 192 to or from the pull-out driving roller 86. The output clutch 194 connects or disconnects the rotational driving force of the conveyance motor 192 to or from the output roller pair 94 serving as an output conveyance unit.

The reading control unit 903 that has received the registration stop signal from the controller 904 transmits a reading start signal, which is a sheet feeding permission signal, to the controller 904. In response, the controller 904 resumes the rotation of the conveyance motor 192 and the reading motor. Based on the pulse count of the reading motor, the timing at which the leading end of the document MS reaches a reading position of the first fixed reader 151 is calculated. At that timing, the controller 904 transmits a gate signal to the reading control unit 903 indicating an effective image area in the sub-scanning direction of the first side of the document MS. This transmission continues until the trailing end of the document MS passes beyond the reading position of the first fixed reader 151, during which the first side of the document MS is read by the first fixed reader 151.

After passing through the first reading and conveying section E, the document MS passes through the first reading exit roller pair 92, and then the leading end of the document MS is detected by the output sensor 61. In a case where the single-sided reading mode is set, reading of the second side of the document MS by the second fixed reader 95 described below is not necessary. When the leading end of the document MS is detected by the output sensor 61, the output clutch 194 transmits the driving force of the conveyance motor to the output roller pair 94. Then, based on the pulse count of an output motor after the leading end of the document MS is detected by the output sensor 61, the timing at which the trailing end of the document MS exits the nip of the output roller pair 94 is calculated. The operation of the output clutch 194 is stopped based on the calculation result.

By contrast, in a case where the double-sided reading mode is set, the time from when the leading end of the document MS is detected by the output sensor 61 to when the leading end of the document MS reaches the second fixed reader 95 is calculated based on the pulse count of the reading motor. At the timing when the leading end of the document MS reaches the second fixed reader 95, the controller 904 transmits a gate signal to the reading control unit 903 indicating an effective image area in the sub-scanning direction of the second side of the document MS. This transmission continues until the trailing end of the document MS passes beyond the reading position of the second fixed reader 95, during which the second side of the document MS is read by the second fixed reader 95.

The second fixed reader 95 includes a contact image sensor (CIS). The reading face of the second fixed reader 95 is coated to prevent a reading vertical streak that may be caused when a pasty foreign substance on the document MS adheres to the reading face. A reading roller 96 serving as a document support that supports the document MS from a non-reading side is disposed opposite the second fixed reader 95. The reading roller 96 prevents the document MS from floating at the reading position of the second fixed reader 95, and functions as a reference white section for the second fixed reader 95 to acquire shading data.

### Features of MFP

The ADF 51 performs the above-described operations to read the information represented on the document MS. However, depending on the condition or type of the document MS, for example, a paper jam may occur in the above-described structure of the ADF 51. Removing a paper jam requires manual effort, and the paper jam may cause damage, such as wrinkles, to the document MS.

To prevent such an unfavorable situation, the copier 100 according to the present embodiment has a configuration to recognize the condition and type of the document MS and prevent the document MS from being damaged.

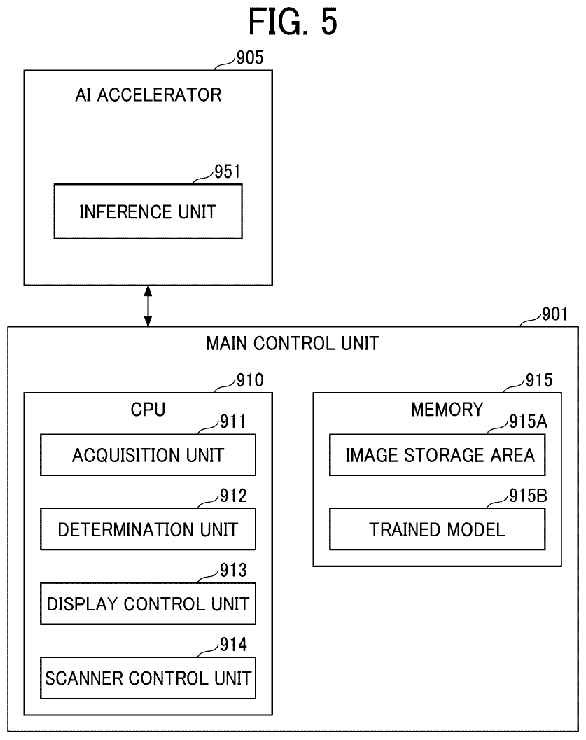

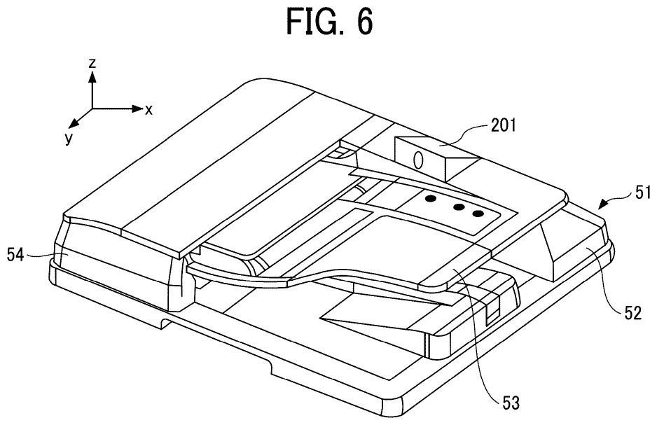

FIG. 5 is a block diagram illustrating a configuration of the main control unit 901 and the AI accelerator 905. FIG. 6 is a perspective view of the ADF 51.

As illustrated in FIG. 6, the ADF 51 includes a camera 201 at a position where the camera 201 can capture images of the ADF input tray 53. The camera 201 is an example of an imager that captures an image of a document, which is an example of a medium. The camera 201 is integrated with the ADF 51. The camera 201 is positioned behind the ADF input tray 53. In other words, the camera 201 is capable of capturing images of the ADF input tray 53, and is positioned not to interfere with the user setting a document on the ADF input tray 53. With the camera 201 described above, the ADF 51 prevents the burden on the user setting the document.

The main control unit 901 includes a CPU 910 and a memory 915. The main control unit 901 is directly connected to the camera 201. The main control unit 901 is also connected to the AI accelerator 905.

The memory 915 includes an image storage area 915A and stores a trained model 915B.

The image storage area 915A is a memory area that temporarily stores image data captured by the camera 201. The image data representing an image captured by the camera 201 may be also referred to as image information.

For example, when image data in which a document appears is input, the trained model 915B outputs the similarity between the document appearing in the image data and a document that can be read by the ADF 51. A document that can be read by the ADF 51 may be referred to as “document recommended for reading” in the following description. In the present embodiment, an example is described in which the similarity between a target document and a document recommended for reading is used as an example of information indicating whether to read the target document based on the condition or type of the medium. The similarity between a target document and a document recommended for reading may be referred to simply as “similarity with a document recommended for reading” in the following description. The information output by the trained model 915B is not limited to the similarity with a document recommended for reading. The information output by the trained model 915B may be any information used to determine whether the document is recommended for reading.

When the image data includes an area having a similarity with a document recommended for reading lower than a predetermined threshold, the trained model 915B may output the area. The trained model 915B may output the condition and type of the document when the similarity is low.

A learning device performs machine learning based on a training dataset to generate the trained model 915B. In other words, the trained model 915B is generated by applying supervised learning to a base training model.

The trained model 915B is obtained through machine learning using a training dataset based on image data acquired by capturing a large number of images in advance.

In particular, the trained model 915B is generated by machine learning based on a training dataset that indicates image data and information indicating whether a document appearing in the image data is readable. Further, the training dataset may include information indicating the condition and type of the document.

As the machine learning used to generate the trained model 915B, for example, a neural network may be applied. As another example, deep learning, which is machine learning using a deep neural network (DNN), may be applied. As deep learning, for example, a convolutional neural network, a recurrent neural network (RNN), or a long short-term memory (LSTM) may be applied.

Machine learning is performed so that the trained model 915B can output information indicating the condition of an unreadable document, such as a wrinkle, a curl, a fold, a tear, stapling, clipping, or crimping of the document; or a sticky note attached to the document, as well as information indicating the type of an unreadable document, such as a document made of a special material, including glossy coated paper or carbonless paper for a copy slip. Such a special material may cause the document to slip during the conveyance of the document or may make it difficult to correct the skew of the document.

The AI accelerator 905 is a hardware component to accelerate model inference processing in a neural network. As the AI accelerator 905, a graphics processing unit (GPU) may be used, or an ASIC dedicated to the AI accelerator may be used.

The AI accelerator 905 is provided with a library to use a trained model. For this reason, the AI accelerator 905 may include an inference unit 951 for the trained model 915B stored in the memory 915. The AI accelerator 905 is capable of executing image recognition using deep learning.

The CPU 910 of the main control unit 901 controls the operation of the copier 100 and the operation inputs from the user. The CPU 910 implements each functional block by executing a program stored in the memory 915. Each functional block in the CPU 910 is conceptual, and is not necessarily physically configured as illustrated in FIG. 5. All or some of the functional blocks may be configured by being functionally or physically distributed or integrated in any unit. The CPU 910 includes an acquisition unit 911, a determination unit 912, a display control unit 913, and a scanner control unit 914 by implementing a program.

The acquisition unit 911 acquires various types of information input into the main control unit 901 and the detection results from various sensors. For example, the acquisition unit 911 acquires a signal indicating whether a document is set on the ADF input tray 53 from the document setting sensor 63. The acquisition unit 911 further acquires image data captured by the camera 201.

The determination unit 912 outputs the image data acquired by the acquisition unit 911 to the AI accelerator 905. The determination unit 912 then receives the similarity between the acquired image data and a document recommended for reading from the AI accelerator 905. The determination unit 912 may further receive information indicating an area having a similarity with the document recommended for reading lower than a predetermined threshold, as well as the condition and type of the document, from the AI accelerator 905.

The determination unit 912 determines whether the similarity with the document recommended for reading is equal to or greater than the predetermined threshold. When the similarity with the document recommended for reading is smaller than the predetermined threshold, the determination unit 912 determines that the condition or type of the document is anomalous.

The determination unit 912 outputs image data to the AI accelerator 905 to receive the result of image recognition by deep learning in real time. The present disclosure is not limited to the example of processing using the AI accelerator 905 herein described. Alternatively, for example, the AI accelerator 905 may be capable of outputting the type and condition of the document as a result of image recognition. The determination unit 912 may then determine whether the document is readable based on the type and condition of the document output from the AI accelerator 905.

The display control unit 913 controls the display of information on the display device 920.

The scanner control unit 914 outputs instructions to the reading control unit 903 of the scanner 150 as to whether to perform reading.

The display control unit 913 and the scanner control unit 914 perform control based on the determination result from the determination unit 912. Accordingly, the main control unit 901 can switch the control based on at least one of a condition and a type of the document, where the at least one of the type and the condition is recognized based on the image data acquired by the acquisition unit 911.

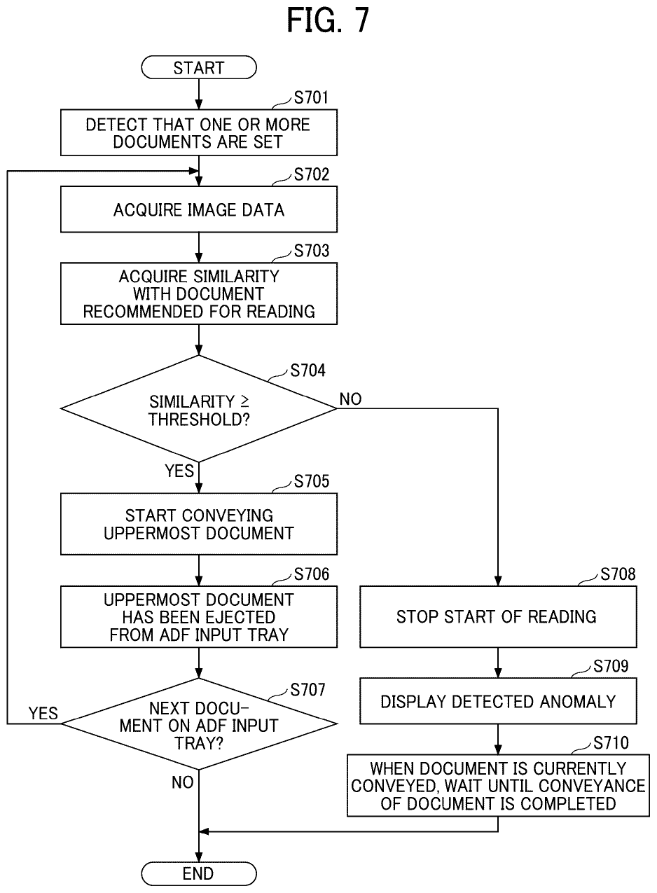

FIG. 7 is a flowchart of a process performed by the main control unit 901 to start reading a document. In the present embodiment, the camera 201 constantly captures images. The image storage area 915A stores the image data captured by the camera 201 for a predetermined period of time (several seconds) regardless of whether the reading is started.

In step S701, the acquisition unit 911 detects that one or more documents are set on the ADF input tray 53 based on a document set signal received from the document setting sensor 63.

In step S702, the acquisition unit 911 acquires the image information stored in the image storage area 915A. The acquisition unit 911 acquires image information (buffered for several seconds) before one or more documents are set, together with image information at the time of detecting that one or more documents are set, which are stored in the image storage area 915A.

As described above, the acquisition unit 911 acquires image data captured by the camera 201 before a document is placed on the ADF input tray 53, allowing the main control unit 901 to perform control based on at least one of a condition and a type of the document, where the at least one of the type and the condition is recognized based on the image data captured before the document is placed on the ADF input tray 53.

In step S703, the determination unit 912 outputs the acquired image information to the inference unit 951 of the AI accelerator 905 and acquires, for example, the similarity with a document recommended for reading from the inference unit 951 of the AI accelerator 905.

In step S704, the determination unit 912 determines whether the similarity with the document recommended for reading is equal to or greater than a predetermined threshold. The threshold is predetermined according to the example or embodiment. Accordingly, a detailed description thereof is omitted.

When the determination unit 912 determines that the similarity with the document recommended for reading is equal to or greater than the predetermined threshold (YES in S704), in step S705, the scanner control unit 914 separates the uppermost document of the documents on the ADF input tray 53 and performs control to start conveying the uppermost document.

In step S706, the acquisition unit 911 recognizes that the uppermost document of the documents on the ADF input tray 53 has been ejected, based on the detection results from various sensors, such as the abutment sensor 72, the document-width sensor 73, and the reading entrance sensor 67. When the ejection of the uppermost document is completed, that is, when the trailing end of the uppermost document exits from the ADF input tray 53, the surface of the next document of the documents on the ADF input tray 53 becomes available for image capturing by the camera 201.

In step S707, the determination unit 912 determines whether the next document is present on the ADF input tray 53 based on the detection results from the various sensors, such as the document setting sensor 63. When the determination unit 912 determines whether the next document is present (YES in S707), the process returns to step S702 and is performed again from step S702. When the process returns to step S702, the main control unit 901 acquires image data of the next document as the uppermost document of the documents on the ADF input tray 53 and performs operations substantially similar to those for the first document.

By contrast, when the determination unit 912 determines that the next document is absent on the ADF input tray 53 based on the detection results from the various sensors, such as the document setting sensor 63 (NO in step S707), the process ends.

When the determination unit 912 determines that the similarity with the document recommended for reading is smaller than the predetermined threshold (NO in S704), in step S708, the scanner control unit 914 performs control to stop the initiation of reading of the uppermost document of the documents on the ADF input tray 53. When the determination unit 912 determines that the similarity with the document recommended for reading is smaller than the predetermined threshold, the determination unit 912 determines that the uppermost document is not in a condition or type to be recommended for reading, and processes the document as being in an anomalous condition.

In step S709, the display control unit 913 displays information indicating the condition or type of the document as a detected anomaly on the display device 920.

For example, when the document determined to be anomalous is the first sheet, the display control unit 913 grays out the color of the copy start button 158 displayed on the display device 920 provided with a touch panel to indicate that the copy start button 158 is currently disabled. Further, the scanner control unit 914 restricts the initiation of conveyance of the uppermost document. For example, when the document is the second or subsequent sheet, the scanner control unit 914 performs control not to start conveying the uppermost document, which is the next page.

When a document is currently conveyed, in other words, when the document determined to be anomalous is the second or subsequent sheet, in step S710, the acquisition unit 911 waits until the processing of the document currently conveyed is completed based on the detection results from the various sensors, such as the abutment sensor 72, the document-width sensor 73, and the reading entrance sensor 67. Thus, the process ends.

The main control unit 901 performs the above-described control based on the type or condition of the document.

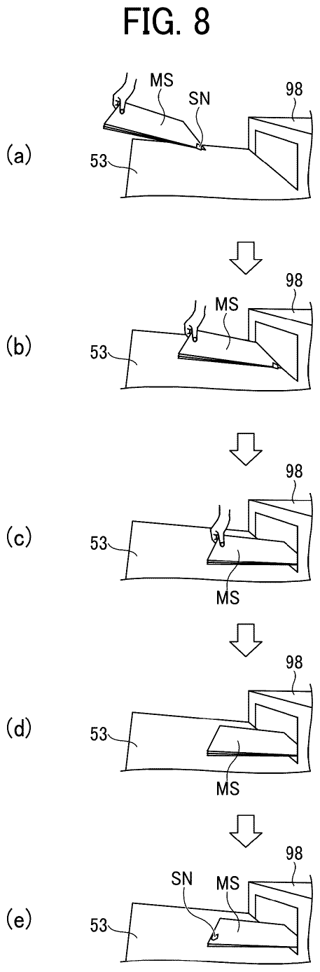

FIG. 8 is a diagram illustrating a change in image data acquired from the camera 201 by the acquisition unit 911. In FIG. 8, the document MS to which a sticky note SN is attached is placed on the ADF input tray 53. The image data captured by the camera 201 changes in the order of FIG. 8 (a) to (e).

When the acquisition unit 911 receives a document set signal from the controller 904, the determination unit 912 transfers multiple pieces of image data buffered in the image storage area 915A, that is, multiple pieces of image data corresponding to several seconds before the document MS is placed on the ADF input tray 53, to the inference unit 951 of the AI accelerator 905, and receives the similarity with a document recommended for reading as a result of image recognition by deep learning.

Before the document MS is placed on the ADF input tray 53, as in the image data illustrated in FIG. 8 (a) and (b), the sticky note SN attached to the document MS can be recognized.

By contrast, when the document MS is placed on the ADF input tray 53, that is, when the document MS is at the document set position, as in the image data illustrated in FIG. 8 (c) and (d), the leading end of the document MS is hidden by the ADF cover 98, and thus the sticky note SN attached to the leading end of the document MS cannot be recognized.

To address such a situation, the determination unit 912 transfers multiple pieces of image data, corresponding to several seconds before the document MS is placed on the ADF input tray 53, to the inference unit 951 of the AI accelerator 905. Accordingly, the main control unit 901 can determine whether the document MS is recommended for reading, including a portion hidden by the ADF cover 98, based on the image data illustrated in FIG. 8 (a) and (b).

Further, the main control unit 901 causes the camera 201 to capture an image of the uppermost document MS of the documents MS on the ADF input tray 53 each time a document MS is ejected or removed by the user, and determines whether the uppermost document MS is recommended for reading based on the captured document data.

As in the image data illustrated in FIG. 8 (e), when the camera 201 captures an image of the document MS to which the sticky note SN is attached as a result of a document being ejected or removed by the user, the main control unit 901 determines that the document MS to which the sticky note SN is attached is present, and stops the conveyance (reading) of the document MS.

A screen displayed on the display device 920 is described below.

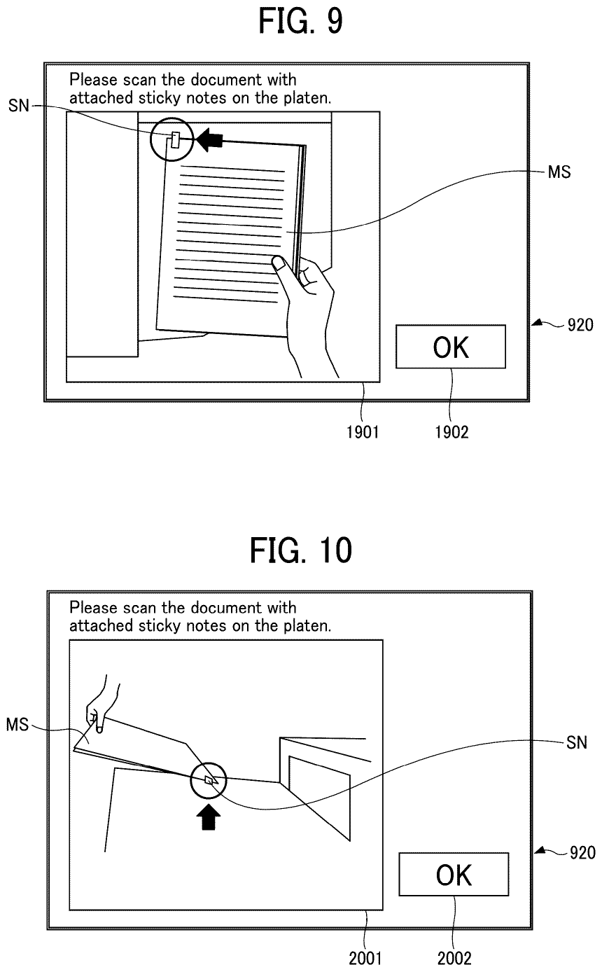

FIG. 9 is a diagram illustrating a first example of a screen displayed by the display control unit 913. In FIG. 9, the document MS is the first sheet, and a message indicating that an anomaly has been detected is displayed on the screen. The message is based on the type or condition of the document received from the inference unit 951.

In FIG. 9, a message “Please scan a document with attached sticky notes on the platen” is displayed. In other words, the display control unit 913 displays information prompting the placement of the document on the second platen 155 for reading, i.e., to be read by the scanner 150, based on a determination that at least one of the condition and the type of the document is anomalous. Accordingly, the main control unit 901 can properly read the document while preventing, for example, a paper jam of the document.

Further, the display control unit 913 may display an image or illustration corresponding to the type or the condition of the document received from the inference unit 951 in a display area 1901. When an image or illustration of the document MS to which the sticky note SN is attached is displayed in the display area 1901, the user can recognize a specific situation. The display control unit 913 further displays an OK button 1902. When the user has eliminated the anomalies of the document MS, the user presses the OK button 1902. In response to the OK button 1902 being pressed, the main control unit 901 starts processing for reading the document MS again. Since the user may erroneously press the OK button 1902 without eliminating the anomalies of the document MS, the main control unit 901 may confirm whether the document MS is removed from the ADF input tray 53. For example, when the OK button 1902 is pressed, the camera 201 may capture an image of the document MS on the ADF input tray 53 again, and the determination unit 912 may determine, based on the captured image data, whether the anomalies of the document MS has been eliminated by the removal of the document MS. Alternatively, when the OK button 1902 is pressed, the camera 201 may capture an image of the document MS on the ADF input tray 53 again, and the determination unit 912 may determine, based on the captured image data, that the anomalies of the document MS has been eliminated by the removal of the sticky note SN from the document MS on the ADF input tray 53.

The present embodiment is not limited to the screen as illustrated in FIG. 9. FIG. 10 is a diagram illustrating a second example of the screen displayed by the display control unit 913.

The screen illustrated in FIG. 10 is different from the screen illustrated in FIG. 9 in the image displayed in a display area 2001. Specifically, image data captured by the camera 201 is displayed in the display area 2001. Further, the display control unit 913 displays an area determined to be anomalous enclosed in a circle. Specifically, an area in which the sticky note SN is captured is circled in the image data in the display area 2001. The document MS including such an area is determined not to be a document recommended for reading. As illustrated in FIG. 10, the circle may be highlighted with an arrow pointing to the circle. Providing such visual information facilitates user recognition of the reason for unsuccessful reading of the document MS. An OK button 2002 is substantially similar to the OK button 1902 in FIG. 9.

The display example of the image data on the display device 920 is not limited to the example illustrated in FIG. 10. For example, the display control unit 913 may cut out and display a part of the image data captured by the camera 201. Alternatively, the display control unit 913 may enlarge and display a part of the image data to which attention is desired to be paid, such as a sticky note and the periphery thereof. Thus, the display control unit 913 displays information indicating an area determined to be anomalous, such as enlarged display or enclosing with a circular mark, together with the image data representing the type or condition of the document determined to be anomalous, based on the image data captured by the camera 201.

The direction of a document appearing in the image data captured by the camera 201 is opposite to the direction of the document as viewed by the user. To address such a situation, the display control unit 913 may display the image data after rotating the image data so that the image data is oriented in the same direction as viewed by the user. Further, the display control unit 913 may modify the image data to resemble an overhead reference view and display the modified image data as illustrated in FIG. 9.

The acquisition unit 911 acquires image data captured by the camera 201 each time a document is conveyed from the ADF input tray 53. The determination unit 912 outputs the acquired image data to the inference unit 951 to perform control based on at least one of the condition and the type of the document, where the at least one of the type and the condition is recognized based on the image data, each time the acquisition unit 911 acquires the image data. For example, when the condition or type of the document is determined to be anomalous, the display control unit 913 displays a message indicating that an anomaly has been detected.

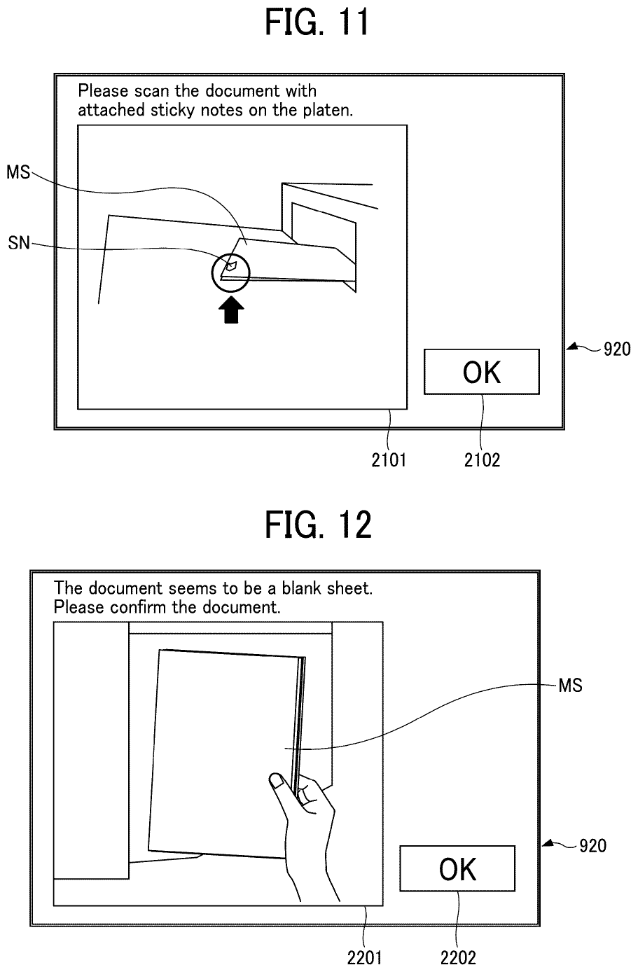

FIG. 11 is a diagram illustrating a third example of the screen displayed by the display control unit 913.

In FIG. 11, the document MS is the second or subsequent sheet, and a message indicating that an anomaly has been detected is displayed on the screen. In a display area 2101 of the screen illustrated in FIG. 11, image data captured by the camera 201 is displayed. Further, the display control unit 913 displays an area determined to be anomalous enclosed in a circle. Specifically, an area in which the sticky note SN is captured is circled in the image data in the display area 2001. The document MS including such an area is determined not to be a document recommended for reading. Providing such visual information facilitates user recognition of the reason for unsuccessful reading of the document MS. An OK button 2102 is substantially similar to the OK button 1902 in FIG. 9.

FIG. 12 is a diagram illustrating a fourth example of the screen displayed by the display control unit 913.

In the ADF 51, the upper side of a document set on the ADF input tray 53 becomes the lower side of the document when the document is conveyed to the reading position. For this reason, when the upper side of the document set on the ADF input tray 53 is blank, the blank side of the document is printed.

To prevent such a situation, in the present embodiment, the trained model 915B may learn to identify a blank document as being in an anomalous condition through machine learning. In this case, when the document is set upside down, the main control unit 901 determines that the document is anomalously set and stops reading the document.

In FIG. 12, the document MS is a blank sheet, and a message indicating that an anomaly has been detected is displayed on the screen. In a display area 2201, image data captured by the camera 201 may be displayed, or an image or illustration indicating that the document MS is blank may be displayed. Providing such visual information facilitates user recognition of the reason for unsuccessful reading of the document MS. An OK button 2202 is substantially similar to the OK button 1902 in FIG. 9.

As described above, the scanner control unit 914 stops the initiation of reading of the medium placed on the ADF input tray 53 when the determination unit 912 determines that at least one of the condition and the type of the document is anomalous.

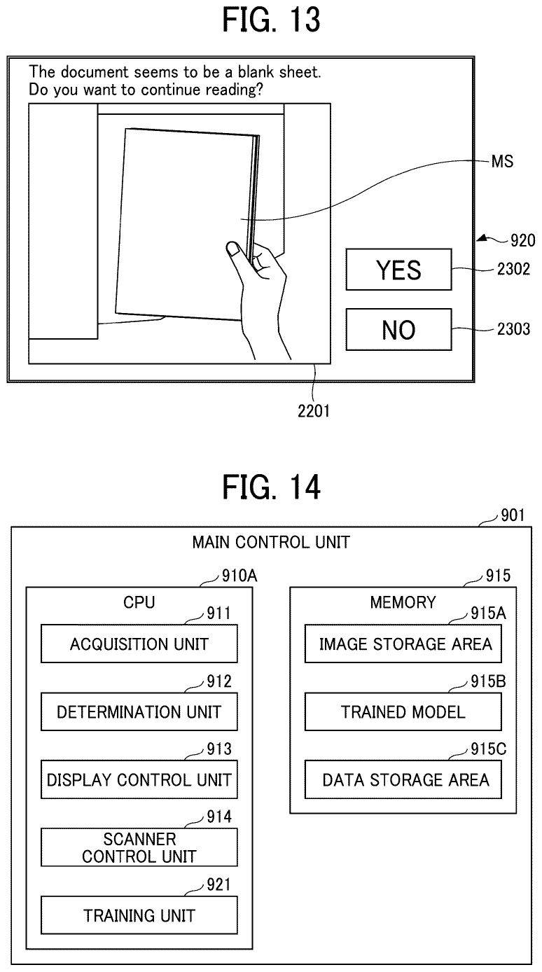

FIG. 13 is a diagram illustrating a fifth example of the screen displayed by the display control unit 913.

When an image on the upper side of the uppermost document is pale or the document is exposed to light, the inference unit 951 may fail to recognize information on the surface of the document from the image data captured by the camera 201 and may recognize the document as a blank sheet. In this case, the user may be allowed to confirm whether to continue reading.

The screen illustrated in FIG. 13 is different from the screen illustrated in FIG. 12 in the displayed message, and a YES button 2302 and a NO button 2303 are displayed. In other words, on the screen illustrated in FIG. 13, a message inquiring whether to continue reading the document is displayed.

The main control unit 901 starts reading the document in response to the YES button 2302 being pressed, and restricts the reading of the document in response to the NO button 2303 being pressed. In FIG. 13, even when the image data of the camera 201 is erroneously recognized as an image not recommended for reading, the document can be read after the user confirms the image data. Accordingly, the user-friendliness is enhanced.

The main control unit 901 can receive a selection of whether to start reading when the condition of the document is determined to be anomalous (blank). In response to the YES button 2302 being pressed, in other words, in response to the selection to start, the scanner control unit 914 starts reading the document placed on the ADF input tray 53. The selection of whether to start reading is not limited to the case where the document is a blank sheet. The main control unit 901 may allow the user to select whether to start reading in the above-described example or when the document is determined to be anomalous, other than a blank sheet.

The copier 100 performs the above-described control to stop reading a document that is not recommended for reading, depending on the condition or type of the document, thus reducing the load on the document. Further, a displayed message indicating that reading cannot be performed allows the user to recognize that the reading is stopped and place the document on the second platen 155 and cause the document to be read (i.e., scanned).

The copier 100 is not limited to the example in which the camera 201 constantly captures images. Alternatively, for example, the camera 201 may capture images while a user is present near the copier 100. For example, the copier 100 may be provided with a human sensor. When the human sensor detects that a user is standing near the copier 100, the main control unit 901 causes the camera 201 to start capturing images. On the other hand, when the human sensor detects that a user has moved away from the copier 100, the main control unit 901 causes the camera 201 to finish capturing images.

### Modified First Embodiment

In the above-described embodiment, the trained model 915B is stored in advance in the copier 100. The trained model 915B may be updated based on image data collected by the copier 100. In the present modification, the trained model 915B is updated as described below.

FIG. 14 is a diagram illustrating a configuration of the main control unit 901 according to the present modification. In the present modification, the other components, such as the AI accelerator 905, are substantially similar to those described in the above embodiment. Accordingly, a detailed description thereof is omitted.

As illustrated in FIG. 14, the main control unit 901 includes a CPU 910A and the memory 915, which is different from the memory 915 described in the above embodiment in that the memory 915 illustrated in FIG. 14 further includes a data storage area 915C. The CPU 910A is different from the CPU 910 described in the above embodiment in that the CPU 910A further includes a training unit 921.

The data storage area 915C stores data for additional training of the trained model 915B.

The data storage area 915C stores at least the image data captured by the camera 201 in association with information indicating whether the document is readable. Further, the data storage area 915C may store information indicating the type or condition of a document in association with image data. The type of the document refers to attributes such as size and material. The condition of the document includes the presence or absence of attachments such as sticky notes, clips, and staples, as well as surface characteristics such as wrinkles, tears, and curling.

The training unit 921 generates training data based on the data stored in the data storage area 915C, and performs additional training of the trained model 915B using the generated training data. The trained model 915B, subjected to additional training, is incorporated into the AI accelerator 905.

The inference unit 951 of the AI accelerator 905 can execute inference processing using the trained model 915B subjected to the additional training.

The inference unit 951 of the AI accelerator 905 is not limited to the example in which the similarity with a document recommended for reading is output when image data is input. Alternatively, the inference unit 951 may output a value indicating the type or condition of the document. Then, the determination unit 912 determines whether to read the document based on the input value. Another trained model may be provided for the determination of whether to read the document, based on the input value.

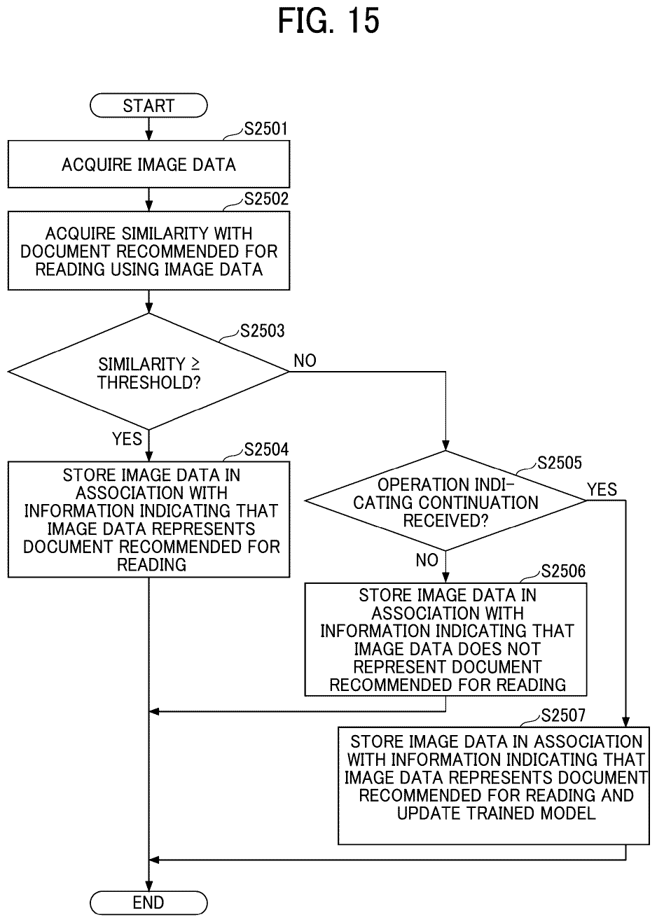

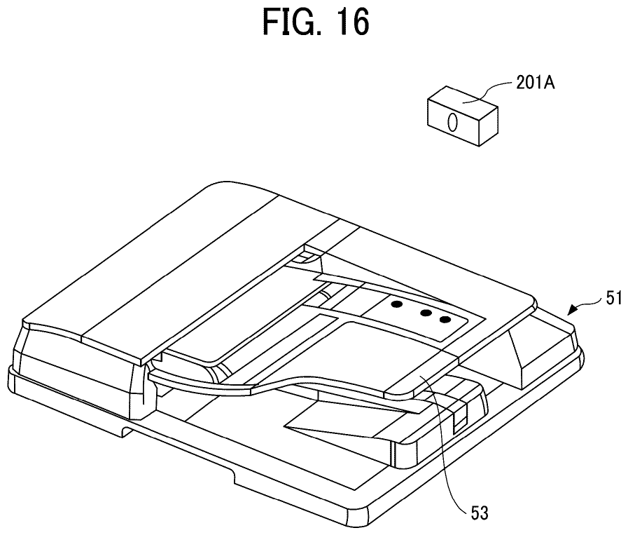

FIG. 15 is a flowchart of a process performed by the main control unit 901 to update the trained model 915B according to the present modification.

At the initiation of reading of a document, in step S2501, the acquisition unit 911 acquires image information stored in the image storage area 915A. The acquisition unit 911 acquires image information (buffered for several seconds) before the document is set, together with image information at the time of detecting that the one or more documents are set, which are stored in the image storage area 915A. As in FIG. 7, the camera 201 may constantly capture images. Alternatively, the camera 201 may capture images while a user is detected near the copier 100.

In step S2502, the determination unit 912 outputs the acquired image information to the inference unit 951 of the AI accelerator 905 and acquires, for example, the similarity with a document recommended for reading from the inference unit 951 of the AI accelerator 905.

In step S2503, the determination unit 912 determines whether the similarity with the document recommended for reading is equal to or greater than a predetermined threshold.

When the determination unit 912 determines that the similarity with the document recommended for reading is equal to or greater than the predetermined threshold (YES in step S2503), in step S2504, the determination unit 912 stores the image data in the data storage area 915C in association with information indicating that the image data represents a document recommended for reading. Optionally, the determination unit 912 may register the image data in the data storage area 915C in association with a recognition result of the condition or type of the document.

When the determination unit 912 determines that the similarity with the document recommended for reading is smaller than the predetermined threshold (NO in step S2503), in step S2505, the determination unit 912 determines whether an operation indicating continuation of document reading has been received from the user.

When the determination unit 912 determines that the operation indicating continuation of document reading has not been received from the user (NO in step 2505), in step S2506, the determination unit 912 stores, in the data storage area 915C, the image data, information indicating that the image data does not represent a document recommended for reading, and the recognition result of the condition or type of the document in association with one another.

By contrast, when the determination unit 912 determines that the operation indicating continuation of document reading has been received from the user (YES in step S2505), in step S2507, the determination unit 912 stores the image data in the data storage area 915C in association with the information indicating that the image data represents a document recommended for reading, whereas the training unit 921 performs additional training of the trained model 915B with the data stored in the data storage area 915C as training data. When the condition or type of the document is input by the user, the determination unit 912 stores the condition or type of the document registered by the user in the data storage area 915C in association with, for example, the image data.

The timing for updating the trained model 915B is not limited to the timing at which the operation indicating continuation of document reading is received from the user, and may be, for example, the timing at which a predetermined number of pieces of data are stored in the data storage area 915C.

According to the present modification, the accuracy of reading a document is enhanced by additional training of the trained model 915B based on a determination result from a user.

A method using a training model with training data has been described in the above embodiment and modification. However, the above-described embodiment and modification are not limited to the method using the training model with training data, and any algorithm may be used. For example, deep learning using a neural network, a training model without training data, or a reinforcement training model may be applied.

### Second Embodiment

In the above-described embodiment, the camera 201 is integrated with the ADF 51. However, the above-described embodiment is not limited to the camera 201 integrated with the ADF 51. In a second embodiment, an example is described in which the camera 201 is separately provided.

FIG. 16 is a perspective view of the ADF 51 and a camera 201A.

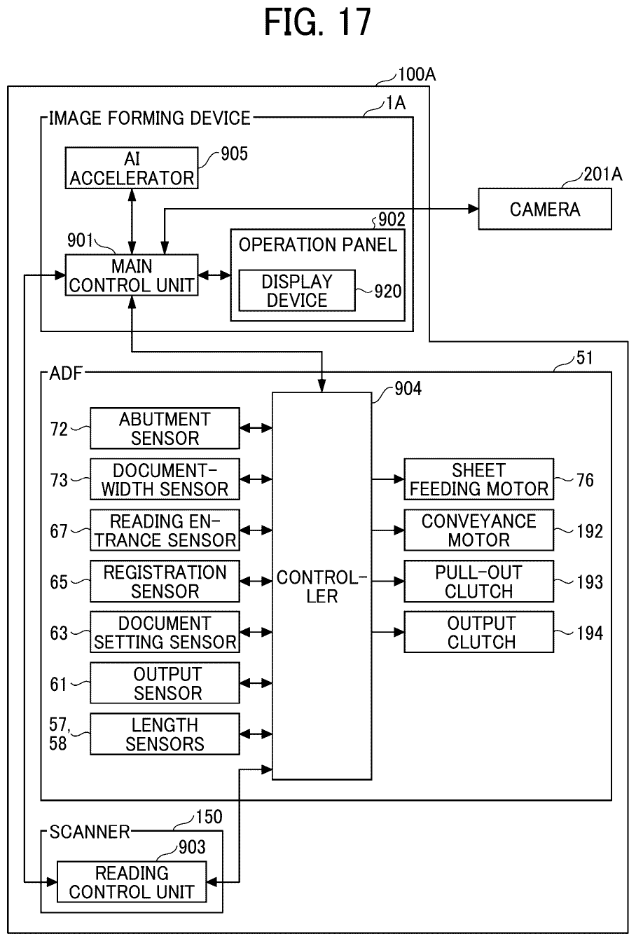

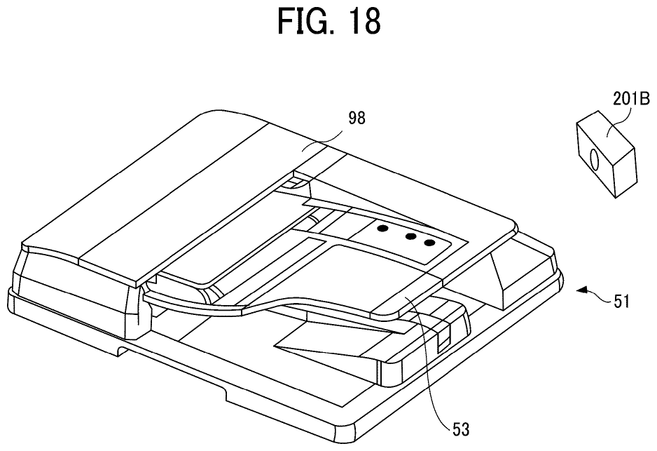

FIG. 17 is a block diagram illustrating a part of an electric circuit of a copier 100A. The copier 100A according to the present embodiment is different from the copier 100 according to the first embodiment in that the camera 201A is separately provided.

The main control unit 901 of an image forming device 1A is connected to the camera 201A positioned external to the copier 100A so as to enable communication. The main control unit 901 and the camera 201A may be connected by any method. The main control unit 901 and the camera 201A may be connected through a signal line or by wireless communication.

The acquisition unit 911 of the main control unit 901 acquires image information captured by the camera 201A positioned external to the copier 100A (including the ADF 51). The subsequent processing is substantially similar to that described in the above embodiment. Accordingly, a detailed description thereof is omitted.

In the present embodiment, the camera 201A is positioned external to the ADF 51. Separately providing the camera 201A and updating the program of the main control unit 901 allow a copier that has been used to perform operations substantially similar to those described in the above embodiment.

The camera 201A may be a camera used for another purpose. For example, a single camera or multiple cameras used for various purposes in, for example, offices or convenience stores may be provided. As a specific example, a camera used for a purpose unrelated to the ADF 51, such as a human sensor, may be provided as the camera 201A. In the present embodiment, a camera for another purpose is provided as the camera 201A to reduce cost.

### Modified Second Embodiment

The above-described embodiments and modification are not limited to the example in which the camera 201 or 201A is disposed at the rear of the copier 100 or 100A or the ADF 51 and oriented toward the front. Another example of arrangement of a camera is described below according to a modified second embodiment.

FIG. 18 is a perspective view of the ADF 51 and a camera 201B according to the present modification. As illustrated in FIG. 18, the camera 201B may be positioned to capture images of the entire ADF cover 98. The camera 201B disposed as illustrated in FIG. 18 is capable of capturing images of the condition of the leading end of the document MS, even when the leading end of the document MS is set in the ADF cover 98. The camera 201B is further capable of capturing images of the condition of the leading end of a second and subsequent documents MS, which may be failed to be captured in the above-described embodiment (for example, in a case where the sticky note SN is attached to the leading end of the second or subsequent document MS to be captured as illustrated in FIG. 11).

The copier 100 or 100A according to the above-described embodiments and modifications does not limit the number of cameras to be connected. For example, the copier 100 or the copier 100A may be connected to both the position of the camera 201 or 201A and the position of the camera 201B.

### Third Embodiment

In the second embodiment and modification, the camera is positioned external to the copier. However, the second embodiment and modification do not limit the configuration provided external to the copier to a camera. In a third embodiment, an example is described in which an anomaly detection function is provided external to the copier, which is an example of the image forming apparatus.

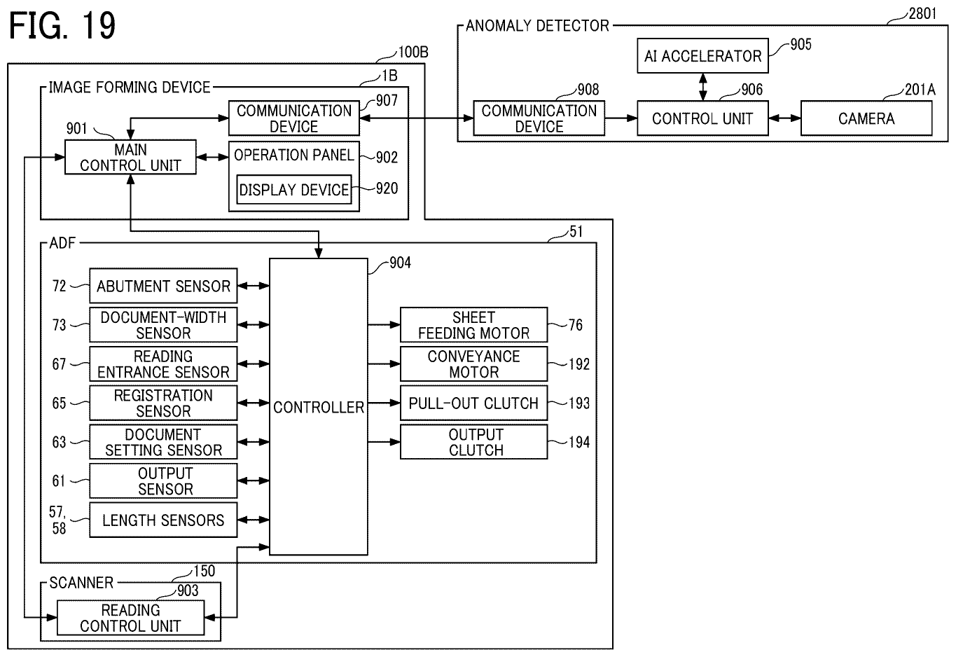

FIG. 19 is a block diagram illustrating a part of electric circuits of a copier 100B and an anomaly detector 2801, which is an example of an anomaly detecting apparatus that detects an anomaly. The copier 100B according to the present embodiment is different from the copier 100 according to the first embodiment in that a configuration for detecting anomalies of documents is separately provided.

The copier 100B illustrated in FIG. 19 includes an image forming device 1B, the ADF 51, and the scanner 150. The image forming device 1B includes the main control unit 901 and the operation panel 902 as in the above-described embodiments, and further includes a communication device 907.

The anomaly detector 2801 includes the camera 201A, a control unit 906, the AI accelerator 905, and a communication device 908.

The communication device 907 of the image forming device 1B and the communication device 908 of the anomaly detector 2801 are communicably connected with each other. The communication device 907 and the communication device 908 may be connected by any means. The communication device 907 and the communication device 908 may be connected through a signal line or by wireless communication.

The communication device 908 of the anomaly detector 2801 receives from the copier 100B information indicating that a document has been set in the ADF 51 of the copier 100B.

The control unit 906 has a configuration substantially similar to that of the determination unit 912 of the main control unit 901 described in the above embodiments. When the communication device 908 receives the information indicating that the document has been set in the ADF 51, the control unit 906 determines whether to recommend reading in the copier 100B based on at least one of the condition and the type of the document, where the at least one of the type and the condition is recognized based on the image data captured by the camera 201A, and generates information indicating the determination result.

The communication device 908 transmits the information generated by the control unit 906 to the copier 100B. Thereafter, the copier 100B can perform control substantially similar to that described in the above embodiments.

In other words, the copier 100B and the anomaly detector 2801 transmit and receive information to and from each other to perform a process substantially similar to that illustrated in FIG. 7 of the above-described embodiment.

Specifically, in step S701 in FIG. 7, the communication device 907 transmits information indicating that a document is set when the acquisition unit 911 receives a document set signal from the document setting sensor 63.

In step S702, the control unit 906 of the anomaly detector 2801 buffers the last few seconds of images from the camera 201A, which constantly captures images.

When the control unit 906 receives the information indicating that a document has been set via the communication device 908, in the S703, the control unit 906 outputs the acquired image information to the AI accelerator 905 and acquires, for example, the similarity with a document recommended for reading from the AI accelerator 905.

In the S704, the control unit 906 determines whether the similarity with the document recommended for reading is equal to or greater than the predetermined threshold. Specifically, when the similarity with the document recommended for reading is smaller than the predetermined threshold, the control unit 906 determines that the document is in a condition or of a type that is not recommended for reading by the ADF 51. The communication device 908 of the anomaly detector 2801 transmits information indicating the determination result to the main control unit 901. At this time, the communication device 908 also notifies the main control unit 901 of both the image data determined not to be recommended for reading, and information indicating the determined condition and type of the document, as well as an area determined not to be recommended for reading.

Operations substantially similar to those described in the above embodiment are performed for steps S705 to S707.

When the process returns to step S702, the main control unit 901 instructs the anomaly detector 2801 through the communication device 907 to perform anomaly detection on the next uppermost document of the documents on the ADF input tray 53. In response to the instruction, the anomaly detector 2801 performs the operations of steps S702 to S704 similarly to the first document. The copier 100B and the anomaly detector 2801 repeat the process until it is determined that the next document is absent in step S707.

When the anomaly detector 2801 determines that the similarity with the document recommended for reading is smaller than the predetermined threshold (NO in step S704), the main control unit 901 performs the operations of steps S708 to S710 as in the above-described embodiment. Accordingly, a detailed description thereof is omitted.

As described above, even when the anomaly detector 2801 is provided separately from the copier 100B, effects substantially similar to those described in the above embodiments can be attained.

### Fourth Embodiment

A fourth embodiment describes an anomaly detecting system 4000 as an example of an anomaly detecting system for detecting anomalies of documents. The anomaly detecting system 4000 includes an anomaly detector as a server via a communication network.

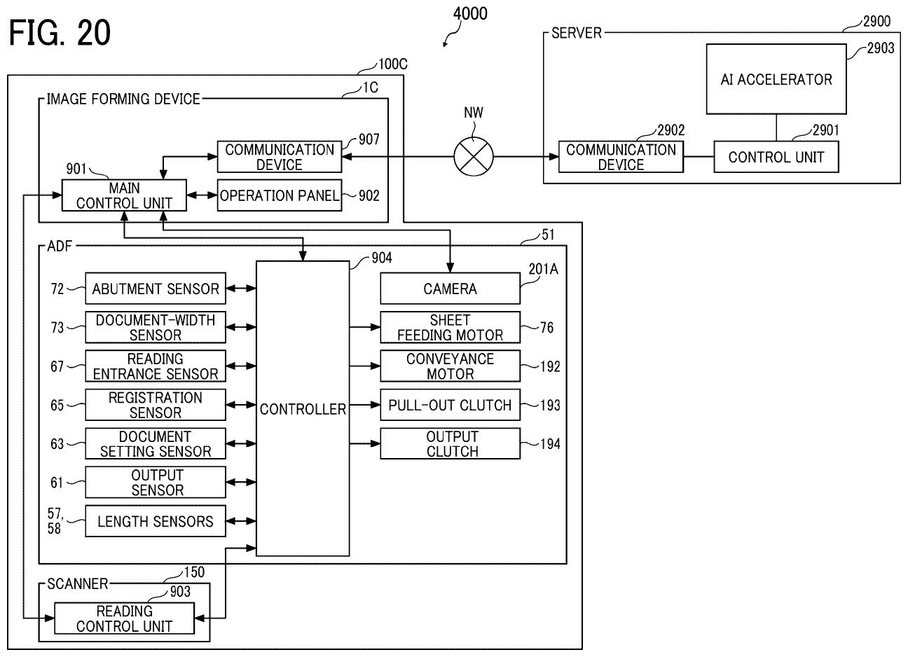

FIG. 20 is a block diagram illustrating a part of electric circuits of a copier 100C and a server 2900. The copier 100C according to the present embodiment is different from the copier 100B according to the third embodiment in that the copier 100C further includes the camera 201A. The camera 201A may be integrated with the ADF 51 provided that the copier 100C is connected to the camera 201A so as to enable communication.

The copier 100C illustrated in FIG. 20 includes an image forming device 1C, the ADF 51, and the scanner 150. The image forming device 1C includes the main control unit 901, the operation panel 902, and the communication device 907 as in the above-described embodiments. Further, the image forming device 1C is connected to the camera 201A.

The server 2900 includes a control unit 2901, a communication device 2902, and an AI accelerator 2903.

The communication device 907 of the image forming device 1C and the communication device 2902 of the server 2900 are communicably connected with each other via a communication network NW. The communication network NW may be a public communication line or a dedicated communication line.

The main control unit 901 of the image forming device 1C includes the acquisition unit 911 that acquires image data of a document loaded into the ADF 51 and captured by the camera 201A, as in the first embodiment described above.

When a document set in the ADF 51 is detected, the communication device 907 transmits the image acquired by the acquisition unit 911 to the server 2900 through the communication device 2902. The image data to be transmitted includes image data buffered for several seconds, as in the above-described embodiments.

The communication device 907 receives from the server 2900 information indicating a determination result indicating whether the document is recommended for reading. When the communication device 907 receives information indicating a determination result that the document is not recommended for reading, the communication device 907 receives from the server 2900 information indicating the condition and type of the document, as well as an area determined not to be recommended for reading.

The main control unit 901 performs control based on the received information. The control to be performed is substantially similar to that described in the above embodiments. Accordingly, a detailed description thereof is omitted.

The communication device 2902 of the server 2900 receives the image data from the copier 100C.

The control unit 2901 of the server 2900 generates information indicating a determination result indicating whether the document is recommended for reading based on a recognition result of at least one of the condition and the type of the document appearing in the image data, using the AI accelerator 2903. The control unit 2901 may generate information indicating the condition and type of the document, as well as the area determined not to be recommended for reading, in response to a determination that the document is not recommended for reading.

The communication device 2902 of the server 2900 transmits the information generated by the control unit 2901 to the copier 100C.

As described above, the anomaly detecting system 4000 attains effects substantially similar to those described in the above embodiments even when a configuration indicating whether a document is recommended for reading is provided as a server based on the type of the document such as coated paper or carbonless paper or the condition of the document such as a fold, a wrinkle, a tear, or a curl.

### Fifth Embodiment

In the embodiments described above, the display device 920 displays information indicating the condition or type of a document when an anomaly is detected. However, the above-described embodiments are not limited to the example in which information is displayed on the display device 920. For example, when the copier reads a large number of documents, the user may leave the copier. In this case, the user may fail to notice the information on an anomaly displayed on the display device 920, and thus, the user may not recognize the anomaly.

A fifth embodiment describes an anomaly detecting system 4100 as an example of an anomaly detecting system that includes a communication terminal capable of communicating with a copier. The communication terminal is a device of a user.

In the present embodiment, a copier and a communication terminal are communicably connected with each other to allow a user who is away from the copier to refer to the communication terminal to confirm an anomaly of a document when the copier detects the anomaly of the document.

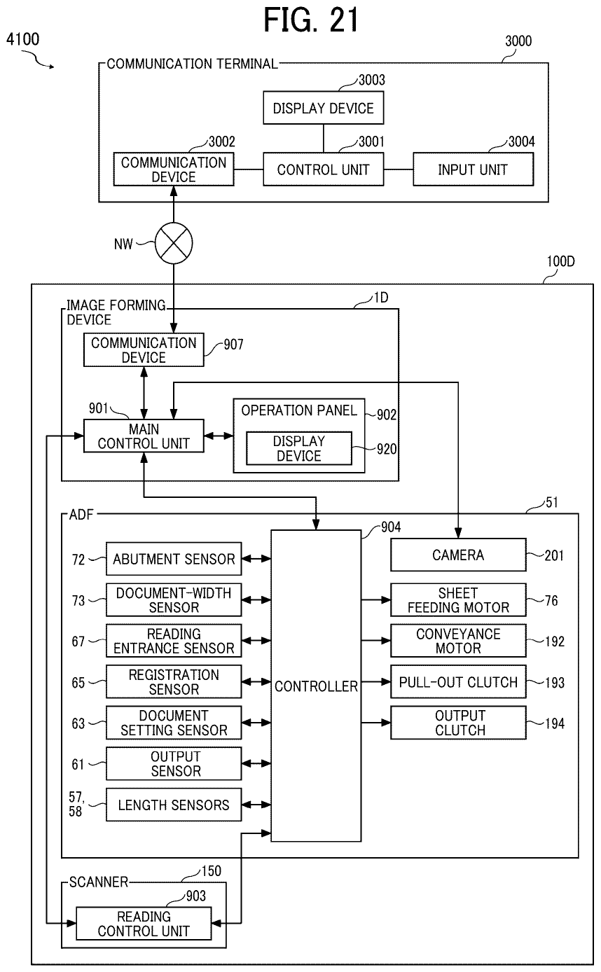

FIG. 21 is a block diagram illustrating a part of electric circuits of a copier 100D and a communication terminal 3000. The copier 100D includes an image forming device 1D, the ADF 51, and the scanner 150. The image forming device 1D includes the main control unit 901 and the operation panel 902 as in the above-described embodiments, and further includes the communication device 907. The image forming device 1D is different from the image forming devices described in the above embodiments in that the image forming device 1D is connected to the communication terminal 3000 so as to enable communication.

The communication device 907 is a communication interface for connecting the copier 100D to the communication network NW, such as the Internet or a local area network (LAN).

The communication network NW may be a public communication line or a dedicated communication line.

In the present embodiment, an example is described in which the copier 100D has a configuration for detecting anomalies of documents. The present embodiment is not limited to the example in which the copier 100D has a configuration for detecting anomalies of documents. For example, the anomaly detector 2801 may be positioned external to the copier 100D as in the above-described embodiments.

The communication terminal 3000 is a communication terminal of a user who can use the copier 100D. The communication terminal 3000 is, for example, a smartphone, a tablet terminal, a mobile phone, or a personal computer (PC).

The communication terminal 3000 includes a control unit 3001, a communication device 3002, a display device 3003, and an input unit 3004.

The control unit 3001 has a configuration of a computer including a central processing unit (CPU), a read-only memory (ROM), and a random-access memory (RAM), and controls the communication terminal 3000.

The communication device 3002 is a communication interface for connecting the communication terminal 3000 to the communication network NW, such as the Internet or a LAN.

The display device 3003 displays various types of information, such as images. The display device 3003 is, for example, a liquid crystal display. The input unit 3004 is a device for receiving operation inputs from a user. The input unit 3004 is, for example, a touch panel on the display device 3003.

The communication network NW allows communication between the communication device 907 of the image forming device 1D and the communication device 3002 of the communication terminal 3000.

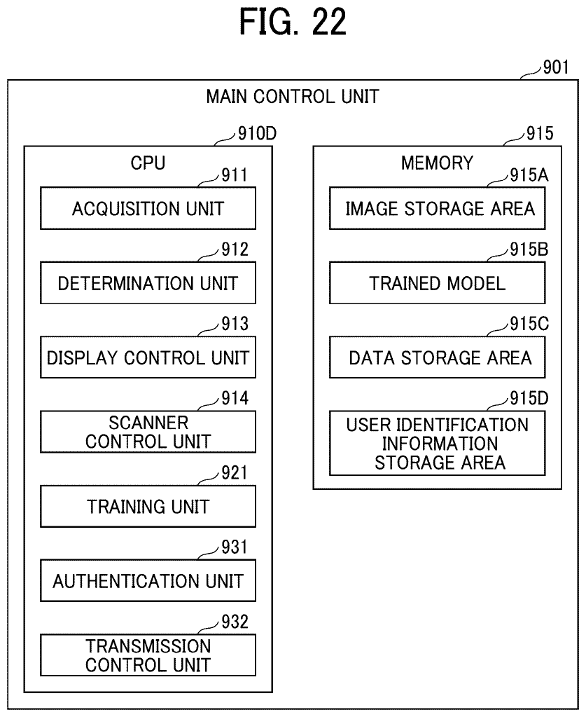

FIG. 22 is a diagram illustrating a configuration of the main control unit 901. As illustrated in FIG. 22, the main control unit 901 includes a CPU 910D and the memory 915. In the present modification, the other components, such as the AI accelerator 905, are substantially similar to those described in the above embodiments. Accordingly, a detailed description thereof is omitted. Identical or similar reference signs are given to components of the main control unit 901 substantially similar to those described in the above embodiments. Accordingly, a detailed description thereof is omitted.

The memory 915 that is illustrated in FIG. 22 is different from the memory 915 described in the above embodiments in that the memory 915 illustrated in FIG. 22 further includes a user identification information storage area 915D. The CPU 910D is different from the CPU 910A described in the above embodiments in that the CPU 910D further includes an authentication unit 931 and a transmission control unit 932.

The user identification information storage area 915D is provided for the identification of a user who uses the copier 100D. The user identification information storage area 915D stores, for example, user identification information in association with terminal identification information for identifying a communication terminal used by the user. Further, the user identification information storage area 915D may store the user identification information in association with user authentication information.

The terminal identification information is used to identify the communication terminal 3000 of the user. The user authentication information may be any information used to verify the identity of the user at the time of login, such as a password.

The user identification information may be any information for identifying the user, such as a user identification (ID) registered in the copier 100D.

The copier 100D is capable of authenticating and identifying one or more users of the copier 100D. The copier 100D is also capable of notifying each communication terminal 3000 used by the user of anomalies of documents.

The authentication unit 931 authenticates a user who uses the copier 100D. For example, the display control unit 913 displays a login screen on the display device 920. The authentication unit 931 authenticates the user based on the information input into the login screen, using the user identification information storage area 915D. When the authentication is successful, services provided by the copier 100D become available for the user.

Further, when the authentication is successful, the authentication unit 931 identifies the terminal identification information indicating the communication terminal 3000 of the user who currently uses the copier 100D.

The transmission control unit 932 performs control to transmit information to an external device through the communication device 907. For example, when the determination unit 912 determines that the condition or type of a document is anomalous, the transmission control unit 932 transmits information indicating the condition or type of the document as information for recognizing the detected anomaly to the communication terminal 3000 indicated by the terminal identification information identified by the authentication unit 931.

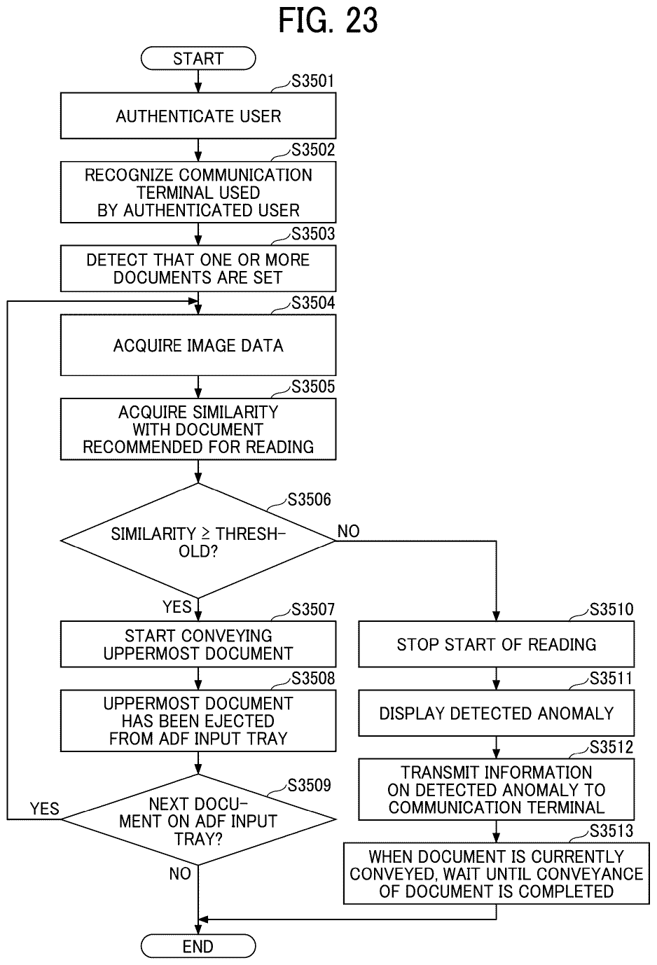

FIG. 23 is a flowchart of a process performed by the main control unit 901 to start reading a document. In the present embodiment, the camera 201 constantly captures images, as in the above-described embodiments. The image storage area 915A stores the image data captured by the camera 201 for a predetermined period of time (several seconds) regardless of whether the reading is started.

In step S3501, the authentication unit 931 compares information input by the user with information stored in the user identification information storage area 915D, and authenticates the user who uses the copier 100D. The information input by the user may be any information for user authentication, such as a user ID and a password.

In step S3502, the authentication unit 931 retrieves and recognizes the terminal identification information indicating the communication terminal 3000 used by the authenticated user from the user identification information storage area 915D.

In steps S3503 to S3505, the main control unit 901 performs operations substantially similar to those of steps S701 to S703 in FIG. 7 of the above-described embodiment.

In step S3506, the determination unit 912 of the main control unit 901 determines whether the similarity with the document recommended for reading is equal to or greater than a predetermined threshold. The threshold is predetermined according to the example or embodiment. Accordingly, a detailed description thereof is omitted.

When the determination unit 912 determines that the similarity with the document recommended for reading is equal to or greater than the predetermined threshold (YES in step S3506), in steps S3507 to S3509, operations substantially similar to those of steps S705 to S707 in FIG. 7 of the above-described embodiment are performed.

When the determination unit 912 determines that the similarity with the document recommended for reading is smaller than the predetermined threshold (NO in S3506), in step S3510, the scanner control unit 914 performs control to stop the initiation of reading of the uppermost document of the documents on the ADF input tray 53.

In step S3511, the display control unit 913 displays information indicating the condition or type of the document as a detected anomaly on the display device 920.

In step S3512, the transmission control unit 932 transmits, through the communication device 907, information indicating the condition or type of the document as information on the detected anomaly to the communication terminal 3000 indicated by the terminal identification information identified by the authentication unit 931. The information indicating the condition or type of the document includes an image representing the document captured by the camera 201. Further, information indicating an area determined to be anomalous is superimposed on the image representing the captured document. For example, an area in which the sticky note SN is captured, as the area determined to be anomalous, is encircled with a circle, as the information indicating the area determined to be anomalous, on the image representing the captured document.

The control unit 3001 of the communication terminal 3000 receives the information on the anomaly through the communication device 3002. The control unit 3001 displays the received information on the anomaly on the display device 3003. The information on the anomaly may be any information that allows the user to recognize the anomaly of the document, such as information indicating an anomaly in the document reading and the condition or type of the read document. In the present embodiment, the information on the anomaly to be displayed includes the received image representing the document.

Further, the control unit 3001 may perform output control to cause the user to recognize the anomaly of the document. For example, the control unit 3001 may display a pop-up screen on the display device 3003 indicating that an anomaly has occurred, may output a notification sound from the communication terminal 3000, or may activate a vibration function of the communication terminal 3000.

After the display device 3003 displays the information on the anomaly, the input unit 3004 receives operation inputs indicating whether to continue reading the document. The control unit 3001 transmits an input result indicating whether to continue reading the document to the communication device 907 of the copier 100D through the communication device 3002. The main control unit 901 of the copier 100D executes processing based on the result of user input received from the communication device 907.

When a document is currently conveyed, in other words, when the document determined to be anomalous is the second or subsequent sheet, in step S3513, the acquisition unit 911 waits until the processing of the document currently conveyed is completed based on the detection results from the various sensors, such as the abutment sensor 72, the document-width sensor 73, and the reading entrance sensor 67. Thus, the process ends.

FIG. 23 does not limit the order of steps, such as the order of steps S3511 and S3512. For example, the main control unit 901 may perform the process by changing the order of steps S3511 and S3512, or may perform the operations of steps S3511 and S3512 in parallel. Further, the transmission control unit 932 may transmit the information on the detected anomaly by assuming that the user is away from the copier 100D after a predetermined time has elapsed since the display control unit 913 displays the information on the detected anomaly on the display device 920.

The present embodiment is not limited to the above-described example in which the communication device 907 of the copier 100D and the communication device 3002 of the communication terminal 3000 are communicably connected with each other. For example, as described in the fourth embodiment, the server 2900 may be provided via the communication network NW. The communication device 3002 of the communication terminal 3000 and the communication device 2902 of the server 2900 may be connected to each other. In this case, the server 2900 may store the user identification information storage area 915D, which associates the user identification information and the terminal identification information for identifying the communication terminal 3000 used by the user, and notify the communication terminal 3000 of an anomaly of a document when the anomaly of the document is detected.

As described above, the anomaly detecting system 4100 is capable of notifying the communication terminal 3000 used by the user who is away from the copier 100D of the information on the detected anomaly, thus allowing the user to recognize the anomaly of the document. In addition to attaining effects substantially similar to those described in the above embodiments, the anomaly detecting system 4100 allows the user who is away from the copier 100D to recognize the anomaly of the document and cope with the anomaly, thus shortening the period in which the processing, such as reading, is stopped.

### Sixth Embodiment

The configuration described above in each embodiment is not limited to application in a device that conveys documents, but may also be applied to a device that conveys printing media. Accordingly, in a sixth embodiment, an example is described in which the configuration is applied to a manual sheet feeder of the copier 100.

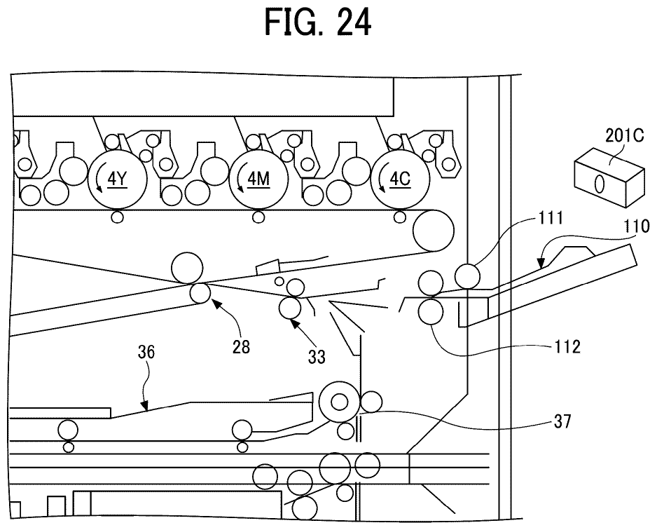

FIG. 24 is a diagram illustrating an example of capturing, with a camera 201C, an image of a transfer sheet set in a manual sheet feeder 110 of the copier 100. The main control unit 901 is connected to the camera 201C so as to enable communication.

In FIG. 24, the main control unit 901 recognizes at least one of the condition and the type of the document appearing in image data captured by the camera 201C, and generates information indicating a determination result indicating whether the document is recommended for reading based on the recognition result.

When the main control unit 901 determines that the document is not recommended for reading, the main control unit 901 may stop reading the document and generate information indicating the condition and type of the document, as well as an area determined not to be recommended for reading. The subsequent processing is substantially similar to that described in the above embodiments and modifications. Accordingly, a detailed description thereof is omitted.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc read-only memory (CD-ROM) or digital versatile disk (DVD), and/or the memory of an FPGA or ASIC.

1. A conveying device, comprising:
a receptacle to receive a medium;
an imager to capture an image of the medium; and
circuitry configured to:
acquire image information of the medium captured by the imager; and
perform control based on at least one of a condition or a type of the medium, the at least one of the condition or the type being recognized based on the acquired image information.

2. The conveying device according to claim 1,
wherein the acquired image information is image information of the medium captured by the imager before the medium is placed on the receptacle.

3. The conveying device according to claim 1, further comprising a display,
wherein the circuitry is configured to display, on the display, a portion represented in the image information and determined to be anomalous, based on a determination that the at least one of the condition or the type of the medium is anomalous.

4. The conveying device according to claim 1,
wherein the circuitry is configured to stop initiation of conveyance of the medium from the receptacle based on a determination that the at least one of the condition or the type of the medium is anomalous.

5. The conveying device according to claim 1,
wherein the imager is integrated with the conveying device and is positioned to capture information represented on the medium.

6. The conveying device according to claim 1,
wherein the imager is positioned external to the conveying device.

7. The conveying device according to claim 1, further comprising a communication device to transmit the acquired image information to an external device and receive, from the external device, information for a determination of control to be performed based on the at least one of the condition or the type of the medium recognized based on the image information,
wherein the circuitry is configured to perform control based on the information received by the communication device.

8. The conveying device according to claim 4,
wherein the circuitry is configured to:
receive a selection of whether to start conveying the medium based on a determination that the at least one of the condition or the type of the medium is anomalous; and
resume conveyance of the medium from the receptacle in response to a selection to start the conveyance of the medium.

9. The conveying device according to claim 4,
wherein the circuitry is configured to perform control to display the image of the medium based on the image information of the medium captured by the imager based on a determination that the at least one of the condition or the type of the medium is anomalous.

10. The conveying device according to claim 9,
wherein the circuitry is configured to display information indicating an area determined to be anomalous, together with the image representing the type or the condition of the medium determined to be anomalous based on the image information of the medium captured by the imager.

11. The conveying device according to claim 1,
wherein the circuitry is configured to:
acquire the image information of the medium captured by the imager each time the medium is conveyed from the receptacle; and
perform the control based on the at least one of the condition or the type of the medium recognized based on the image information, each time the circuitry acquires the image information.

12. The conveying device according to claim 1, further comprising a memory that stores a trained model to output information indicating whether to read the medium based on the condition or the type of the medium in response to an input of the image information representing a surface of the medium,
wherein the circuitry is configured to input the image information into the trained model and perform control based on a result received from the trained model.

13. The conveying device according to claim 12,
wherein the circuitry is configured to perform additional training of the trained model with the image information of the medium captured by the imager and information indicating whether to read the medium based on a manual operation as training data.

14. The conveying device according to claim 1, further comprising a communication device to communicate with a communication terminal of a user using the conveying device via a communication network,
wherein the circuitry is configured to transmit information indicating an anomaly in the at least one of the condition or the type of the medium to the communication terminal through the communication device based on a determination that the at least one of the condition or the type of the medium is anomalous.

15. The conveying device according to claim 14,
wherein the circuitry is configured to transmit the image information representing a portion determined to be anomalous to the communication terminal as information indicating the anomaly in the at least one of the condition or the type of the medium.

16. An image reading device, comprising:
the conveying device according to claim 1; and
a reader to read information represented on the medium conveyed by the conveying device.

17. The image reading device according to claim 16, further comprising:
another reader to read the information represented on the medium placed in a readable area at a position different from the receptacle while moving; and
a display,
wherein the circuitry is configured to display, on the display, information prompting placement of the medium in the readable area for reading, based on a determination that the at least one of the condition or the type of the medium is anomalous.

18. An image forming apparatus, comprising:
the image reading device according to claim 16; and
an image forming device to form an image on another medium based on the information read by the image reading device.

19. An anomaly detecting apparatus, comprising:
a communication device to receive information indicating that a medium is placed on a receptacle of an image reading device, from the image reading device that reads information represented on the medium while conveying the medium; and
circuitry configured to generate, in response to the information received by the communication device, information indicating whether to read the medium based on at least one of a condition or a type of the medium, the at least one of the condition or the type being recognized based on image information of the medium captured by an imager,
wherein the communication device transmits the generated information to an image forming apparatus.

20. An anomaly detecting system, comprising:
an image forming apparatus; and
an information processing apparatus,
the image forming apparatus including:
a reading device to convey a medium from a receptacle to read information represented on the medium;
an imager to capture an image of the medium;
first circuitry configured to acquire image information of the medium captured by the imager;
a first communication device to transmit the acquired image information to the information processing apparatus and receive information indicating whether to read the medium based on the image information from the information processing apparatus,
the first circuitry being configured to perform control based on the received information; and
an image forming device to form an image on another medium based on the information read by the reading device,
the information processing apparatus including:
a second communication device to receive the image information; and
second circuitry configured to generate information indicating whether to cause the reading device to read the medium based on at least one of a condition or a type of the medium, the at least one of the condition or the type being recognized based on the received image information,
wherein the second communication device transmits the generated information to the image forming apparatus.
